(19) United States
(12) Patent Application Publication
(10) Pub. No.: US 2025/0224604 A1
(43) Pub. Date: Jul. 10, 2025

(54) LIGHT IRRADIATION DEVICE, MICROSCOPE, LIGHT IRRADIATION METHOD, AND IMAGE ACQUISITION METHOD

(71) Applicant: HAMAMATSU PHOTONICS K.K., Hamamatsu-shi, Shizuoka (JP)

(72) Inventors: Naoya MATSUMOTO, Hamamatsu-shi, Shizuoka (JP); Koyo WATANABE, Hamamatsu-shi, Shizuoka (JP)

(73) Assignee: HAMAMATSU PHOTONICS K.K., Hamamatsu-shi, Shizuoka (JP)

(21) Appl. No.: 18/700,336

(22) PCT Filed: May 17, 2022
(86) PCT No.: PCT/JP2022/020565

§ 371 Date: Apr. 11, 2024

(30) Foreign Application Priority Data
Oct. 28, 2021 (JP) 2021-176276

(51) Int. Cl. G02B 21/00

(52) U.S. Cl. CPC G02B 21/0076; G02B 21/0032; G02B 21/0056; G02B 21/0068; G02B 21/008

(57) ABSTRACT

A light irradiation device includes a light output unit that outputs coherent beam; and an optical system that irradiates an object with the beam output from the light output unit. The optical system includes an objective lens that focuses the beam output from the light output unit on the object, and a polarization converter, a phase converter, and a ring mask provided on an optical path between the light output unit and the object. The polarization converter is configured to convert the beam input to the polarization converter into azimuthally polarized beam, and to output the azimuthally polarized beam. The phase converter is configured to apply a phase modulation using a spiral phase pattern to the beam input to the phase converter.

### TECHNICAL FIELD

The present disclosure relates to a light irradiation device, a microscope device, a light irradiation method, and an image acquisition method.

### BACKGROUND ART

Non Patent Literature 1 discloses a two-photon microscope. In the two-photon microscope, excitation beam is generated by combining azimuthally polarized light and a phase modulation using a spiral phase pattern. Non Patent Literature 2 discloses a configuration that combines azimuthally polarized light, a phase modulation using a spiral phase pattern, and an amplitude modulation. Non Patent Literature 3 discloses a phase modulation type multiple ring mask.

### CITATION LIST

### Non Patent Literature

Non Patent Literature 1: Xiangping Li et al., “Super-resolved pure-transverse focal fields with an enhanced energy density through focus of an azimuthally polarized first-order vortex beam”, Optics Letters, Volume 39, No. 20, pp. 5961 to 5964 Oct. 15, 2014
Non Patent Literature 2: G. H. Yuan et al., “Generation of nondiffracting quasi-circular polarization beams using an amplitude modulated phase hologram”, Journal of the Optical Society of America A, Volume 28, No. 8, pp. 1716 to 1720 August 2011
Non Patent Literature 3: M. Martinez-corral et al., “Tailoring the axial shape of the point spread function using the Toraldo concept”, Optics Express, Volume 10, Issue 1, pp. 98 to 103, February 2002

### SUMMARY OF INVENTION

### Technical Problem

When an object to be observed is observed or a workpiece is processed, a beam output from a light source such as a laser light source passes through a condenser lens, and is focused on the surface or inside of an object (the object to be observed or the workpiece), and the surface or inside is irradiated with the beam. When the beam is focused in such a manner, a beam waist diameter that is a measure of the size of a focusing diameter thereof can be reduced to only approximately half the wavelength of the beam. This is called a diffraction limit.

A ring mask is used to reduce the focusing diameter beyond the diffraction limit. For example, a single ring mask includes a single light-shielding portion having a ring shape and transmitting portions provided inside and outside the light-shielding portion. Beams that have passed through the transmitting portions inside and outside the light-shielding portion pass through the condenser lens, and reach a focusing position. By causing the two beams to interfere with each other at the focusing position, the beams can be focused in a region smaller than the diffraction limit. The multiple ring mask includes a plurality of light-shielding portions having a ring shape and disposed concentrically, and a plurality of transmitting portions provided between the plurality of light-shielding portions. Beam that has passed through each transmitting portion passes through the condenser lens, and reaches the focusing position. Even when such a multiple ring mask is used, the beam can be focused in a smaller region beyond the diffraction limit.

When the ring mask is used, in order to minimize the focusing diameter, the widths of the light-shielding portion and the transmitting portion may be adjusted according to the numerical aperture of an objective lens. However, even when the widths of the light-shielding portion and the transmitting portion are adjusted to minimize the focusing diameter, the degree of reduction in diameter may be small or the diameter may not be reduced at all. Such a phenomenon becomes more remarkable as the numerical aperture of the objective lens is increased.

An object of the present disclosure is to provide a light irradiation device, a microscope device, a light irradiation method, and an image acquisition method capable of increasing the degree of reduction in focusing diameter when a ring mask is used.

### Solution to Problem

A light irradiation device according to one aspect of the present disclosure includes a light output unit that outputs coherent beam; and an optical system that irradiates an object with the beam output from the light output unit. The optical system includes an objective lens that focuses the beam output from the light output unit on the object, and a polarization converter, a phase converter, and a ring mask that are provided on an optical path between the light output unit and the object. The polarization converter is configured to convert the beam input to the polarization converter into azimuthally polarized beam, and to output the azimuthally polarized beam. The phase converter is configured to apply a phase modulation using a spiral phase pattern to the beam input to the phase converter. According to the findings of the inventors, by providing the polarization converter that converts the beam into azimuthally polarized beam and the phase converter that applies a phase modulation using a spiral phase pattern, in addition to the ring mask, the degree of reduction in focusing diameter can be increased.

A light irradiation method according to one aspect of the present disclosure includes outputting coherent beam; and performing a polarization conversion process, a phase conversion process, and a ring mask process on the beam output in the outputting the beam, and focusing the beam on an object. The polarization conversion process is a process of converting the beam, which is output in the outputting the beam, into azimuthally polarized beam. The phase conversion process is a process of applying a phase modulation using a spiral phase pattern to the beam output in the outputting the beam. According to the findings of the inventors, by providing the polarization conversion process of converting the beam into azimuthally polarized beam and the phase conversion process of applying a phase modulation using a spiral phase pattern, in addition to the ring mask process, the degree of reduction in focusing diameter can be increased.

In the light irradiation device and the light irradiation method, the ring mask and ring mask process may be of an amplitude modulation type. Examples of the ring mask include an amplitude modulation type, a phase modulation type, and a composite type thereof. Since a light use efficiency of the phase modulation type is higher than a light use efficiency of the amplitude modulation type, according to the phase modulation type, the irradiation with the beam can be efficiently performed while reducing loss. However, when the phase modulation type ring mask is used, unnecessary focused portions, namely, side lobes are likely to occur on both sides of a focused spot in an optical axis direction. For example, in a single-photon excitation fluorescence microscope or the like, since a confocal optical system can be used to increase the resolution through the confocal effect caused by a pinhole, the occurrence of such unnecessary focused portions is allowed to some extent. However, for example, in a two-photon excitation fluorescence microscope or the like, the excitation efficiency is lower than that of the single-photon excitation type, and during observation of a deep portion, a large deviation occurs between the pinhole position and the focusing position due to the influence of an aberration, so that the optical loss is large. When the amplitude modulation type ring mask is used, unnecessary focused portions (side lobes) are reduced compared to the phase modulation type, so that the need to provide a confocal optical system including a pinhole is eliminated. Therefore, this can contribute to downsizing of the device while suppressing optical loss.

In the light irradiation device, a ratio (NA/R) of a numerical aperture NA of the objective lens to a refractive index R of a medium between the objective lens and the object may be 0.75 or more. In the light irradiation of the light irradiation method, the beam may be focused using an objective lens in which a ratio (NA/R) of a numerical aperture NA of the objective lens to a refractive index R of a medium between the objective lens and the object is 0.75 or more. According to the light irradiation device and the light irradiation method, when the numerical aperture of the objective lens is large in such a manner, the degree of reduction in focusing diameter can be further increased.

In the light irradiation device, one or both of the phase converter and the ring mask may be formed of phase modulation type spatial light modulator. In the light irradiation method, one or both of the phase conversion process and the ring mask process may be performed using phase modulation type spatial light modulator. In this case, a change in the phase pattern in the phase converter and the phase conversion process and/or a change in the widths of light-shielding portions and transmitting portions in the ring mask and the ring mask process can be easily performed.

In the light irradiation device, the spatial light modulator forming the phase converter may be common with the spatial light modulator forming the ring mask. The spatial light modulator may present a phase pattern in which a phase pattern forming the phase converter and a phase pattern forming the ring mask are superimposed. In the light irradiation method, the spatial light modulator that performs the phase conversion process may be common with the spatial light modulator that performs the ring mask process. The spatial light modulator may present a phase pattern in which a phase pattern for performing the phase conversion process and a phase pattern for performing the ring mask process are superimposed. In this case, components forming the phase converter and components forming the ring mask, or components that perform the phase conversion process and components that perform the ring mask process are combined into one, so that the configuration of the device can be simplified.

In the light irradiation device, the ring mask may include a plurality of light-shielding portions having a ring shape and provided around a center position, a first transmitting portion provided between two adjacent light-shielding portions among the plurality of light-shielding portions, a second transmitting portion located in an innermost layer and provided inside the light-shielding portion located in an innermost layer among the plurality of light-shielding portions, and a third transmitting portion located in an outermost layer and provided outside the light-shielding portion located in an outermost layer among the plurality of light-shielding portions. The degree of reduction in focusing diameter can be further increased by using such a multiple ring mask.

A microscope device according to one aspect of the present disclosure includes the light irradiation device according to any one of the above descriptions; a detector; and an image generator. The detector detects light generated in the object by the irradiation with the beam output from the light output unit. The image generator generates an observation image of the object based on a detection result in the detector. An image acquisition method according to one aspect of the present disclosure includes: the light irradiation method according to any one of the above descriptions; detecting light generated in the object by irradiation with the beam in the focusing the beam; and generating an observation image of the object based on a detection result in the detecting the light. According to the microscope device and the image acquisition method, the degree of reduction in focusing diameter can be increased by including the light irradiation device according to any one of the above descriptions or including the light irradiation method according to any one of the above descriptions. Therefore, the resolution of the observation image can be increased.

In the microscope device, the detector may detect fluorescence generated in the object due to a multiphoton excitation by the irradiation with the beam output from the light output unit. In the detecting the light in the image acquisition method, fluorescence generated in the object due to a multiphoton excitation by the irradiation with the beam in the focusing the beam may be detected. In the microscope device and the image acquisition method that are of a multiphoton excitation type as well, the resolution of an observation image can be increased.

In the microscope device, the light output unit may output a beam of which a time waveform of a light intensity includes an n-th root (n is an integer of 2 or more) of a linear function of a sine wave and of which a maximum value of the light intensity is larger than a saturation excitation intensity of the object. The detector may detect a second harmonic included in a time waveform of a light intensity of the fluorescence generated in the object due to an n-photon excitation by the irradiation with the beam output from the light output unit. In the outputting the beam in the image acquisition method, beam of which a time waveform of a light intensity includes an n-th root (n is an integer of 2 or more) of a linear function of a sine wave and of which a maximum value of the light intensity is larger than a saturation excitation intensity of the object may be output. In the detecting the light, a second harmonic included in a time waveform of a light intensity of the fluorescence generated in the object due to an n-photon excitation by the irradiation with the beam in the focusing the beam may be detected.

In the microscope device and the image acquisition method, the time waveform of the light intensity of the beam, namely, excitation beam output in the light output unit and the beam outputting includes the n-th root of a linear function of a sine wave. In n-photon excitation, the fluorescence intensity is proportional to the n-th power of the excitation beam intensity. Therefore, when the object is irradiated with excitation beam having a time waveform including the n-th root of a linear function of a sine wave, to cause n-photon excitation to occur in the object, the time waveform of the fluorescence output from the object is proportional to the linear function of the sine wave. Therefore, similarly to a general saturated excitation (SAX) microscope, an observation image can be obtained based on a lower-order harmonic such as a second harmonic or a third harmonic. Therefore, according to the microscope device and the image acquisition method, the need to reduce the frequency of the excitation beam due to a limitation on the frequency range of the device that detects fluorescence is eliminated, so that an increase in the time required to create an observation image can be avoided.

### Advantageous Effects of Invention

According to the present disclosure, it is possible to provide the light irradiation device, the microscope device, the light irradiation method, and the image acquisition method capable of increasing the degree of reduction in focusing diameter when the ring mask is used.

### BRIEF DESCRIPTION OF DRAWINGS

FIG. 1 is a diagram schematically showing a configuration of a light irradiation device according to a first embodiment.

FIG. 2 is a diagram showing a polarization direction of azimuthally polarized beam in a plane perpendicular to an optical axis.

FIG. 3 is a figure showing focused images of the azimuthally polarized beam.

FIG. 4 is a figure showing a spiral phase pattern.

FIG. 5 is a figure showing focused images when a phase modulation using the spiral phase pattern is applied to the azimuthally polarized beam.

FIG. 6 is a diagram showing one example of a configuration of a ring mask when viewed in an optical axis direction.

FIG. 7 including parts (a) to (e) is a diagram showing examples of the arrangement order of a polarization converter, a phase converter, and the ring mask.

FIG. 8 is a diagram showing one example of an optical scanner.

FIG. 9 is a flowchart for describing operation of a microscope device.

FIG. 10 including parts (a) and (b) is a diagram showing focused spot shapes in cross sections including the optical axis and parallel to the optical axis.

FIG. 11 is a graph showing a lateral resolution ratio for each aperture ratio when the ring mask is not used.

FIG. 12 is a graph showing a lateral resolution ratio for each aperture ratio when the ring mask is used.

FIG. 13 is a figure showing focused images in cross sections including the optical axis and parallel to the optical axis direction.

FIG. 14 is a diagram schematically showing a configuration of a light irradiation device according to a first modification example.

FIG. 15 is a diagram showing an example of a phase pattern forming the amplitude modulation type ring mask.

FIG. 16 is a diagram showing another example of the phase pattern forming the amplitude modulation type ring mask.

FIG. 17 is a diagram schematically showing a configuration of a microscope device according to a second embodiment.

FIG. 18 is a flowchart for describing operation of the microscope device.

FIG. 19 is a diagram schematically showing a configuration of a microscope device according to a second modification example.

FIG. 20 is a diagram schematically showing a configuration of a microscope device according to a third embodiment.

FIG. 21 is a diagram showing a time waveform of excitation beam.

FIG. 22 is a flowchart for describing operation of the microscope device.

FIG. 23 includes (a) a diagram conceptually showing a fluorescence intensity distribution in a SAX microscope, and (b) a diagram conceptually showing a difference between the theoretical value and the measured value of a fluorescence intensity.

FIG. 24 includes (a) a diagram conceptually showing a time waveform of an excitation beam intensity, and (b) a diagram conceptually showing a time waveform of the fluorescence intensity.

FIG. 25 includes (a) a diagram conceptually showing a time waveform of the excitation beam intensity, and (b) a diagram conceptually showing a time waveform of the fluorescence intensity.

FIG. 26 includes (a) a graph showing the result of Fourier transformation of the time waveform of a light intensity of fluorescence measured in the microscope device of the third embodiment, and (b) a graph showing the result of Fourier transformation of the time waveform of a fluorescence intensity measured when the time waveform of the excitation beam intensity is a sine wave.

FIG. 27 includes (a) a graph showing a relationship between the light intensities of the fundamental wave and the second harmonic of the fluorescence measured in the microscope device of the third embodiment and the relative intensity of the excitation beam, and (b) a graph showing a relationship between the light intensities of the fundamental wave, the second harmonic, and the third harmonic of fluorescence measured when the time waveform of the excitation beam intensity is a sine wave and the relative intensity of the excitation beam.

FIG. 28 is a figure showing fluorescence images in which the fundamental wave is detected in cross sections including the optical axis and parallel to the optical axis direction.

FIG. 29 is a figure showing fluorescence images in which the second harmonic is detected in cross sections including the optical axis and parallel to the optical axis direction.

FIG. 30 is a figure showing fluorescence images in which the third harmonic is detected in cross sections including the optical axis and parallel to the optical axis direction.

FIG. 31 is a diagram conceptually showing a time waveform of excitation beam.

FIG. 32 is a graph conceptually showing a relationship between an applied voltage and an output light intensity of a general AO modulator.

FIG. 33 is a diagram schematically showing a configuration of a light irradiation device according to a fourth modification example.

### DESCRIPTION OF EMBODIMENTS

Hereinafter, embodiments of a light irradiation device, a microscope device, a light irradiation method, and an image acquisition method according to the present disclosure will be described in detail with reference to the accompanying drawings. The present invention is not limited to these examples, but is intended to include all changes indicated by the claims and within the concept and scope equivalent to the claims. In the following description, the same components in the description of the drawings are denoted by the same reference signs, and duplicate descriptions will not be repeated.

### First Embodiment

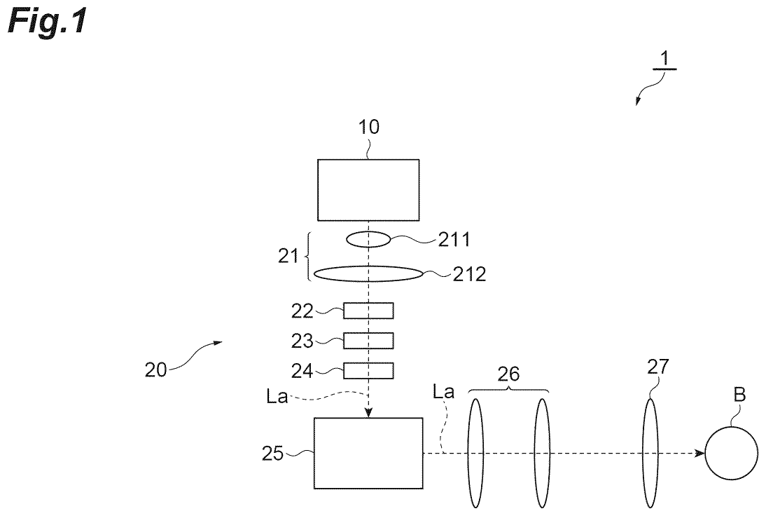

FIG. 1 is a diagram schematically showing a configuration of a light irradiation device 1 according to one embodiment of the present disclosure. The light irradiation device 1 is used, for example, in an optical microscope to irradiate an object to be observed with light. Alternatively, the light irradiation device 1 is used, for example, in a laser processing device to irradiate a workpiece with laser beam. The light irradiation device 1 includes a light output unit 10 and an optical system 20.

The light output unit 10 outputs coherent beam La. The light output unit 10 is, for example, a pulsed light source, and outputs a pulsed beam La. In that case, a pulse width of the beam La is, for example, on the order of picoseconds or femtoseconds. Here, the pulse width of the beam La is, for example, a time for which the light intensity of the beam La is higher than half the peak value of the pulse. Specifically, the pulse width of the beam La is, for example, within a range of 10 femtoseconds to 50 picoseconds. The light output unit 10 is, for example, a laser light source, and in one example, is a mode-locked laser light source. A wavelength of the beam La is included in, for example, the near-infrared region. Specifically, the wavelength of the beam La is, for example, within a range of 650 nm to 1800 nm.

The optical system 20 is an optical system that irradiates an object B, which is an object to be observed or a workpiece, with the beam La output from the light output unit 10. The optical system 20 includes an optical path of the beam La that reaches the object B from the light output unit 10. The optical system 20 includes a beam expander 21, a polarization converter 22, a phase converter 23, a ring mask 24, an optical scanner 25, a relay lens system 26, and an objective lens 27. The beam expander 21 and the optical scanner 25 are provided on an optical path between the light output unit 10 and the objective lens 27. In the shown example, the polarization converter 22, the phase converter 23, and the ring mask 24 are provided on an optical path between the beam expander 21 and the optical scanner 25.

The beam expander 21 is optically coupled to the light output unit 10 via a space, and expands the beam diameter of the beam La output from the light output unit 10. The beam expander 21 includes, for example, a pair of lenses 211 and 212 optically coupled to each other. One lens 211 is provided at the front stage, namely, at a position closer to the light output unit 10 than the lens 212, and the other lens 212 is provided at the rear stage, namely, at a position farther from the light output unit 10 than the lens 211. The lens 211 at the front stage diffuses the beam La. The lens 212 at the rear stage collimates the beam La. The lenses 211 and 212 are, for example, glass lenses.

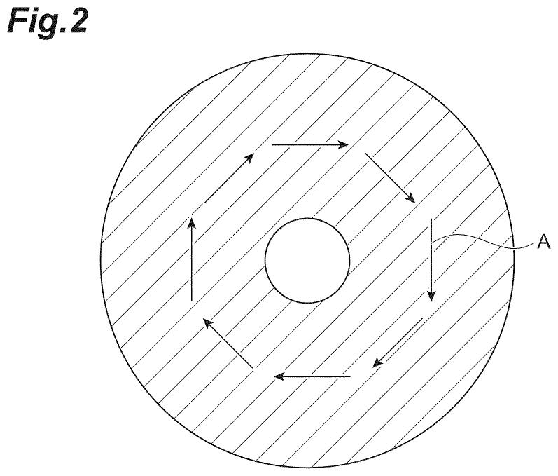

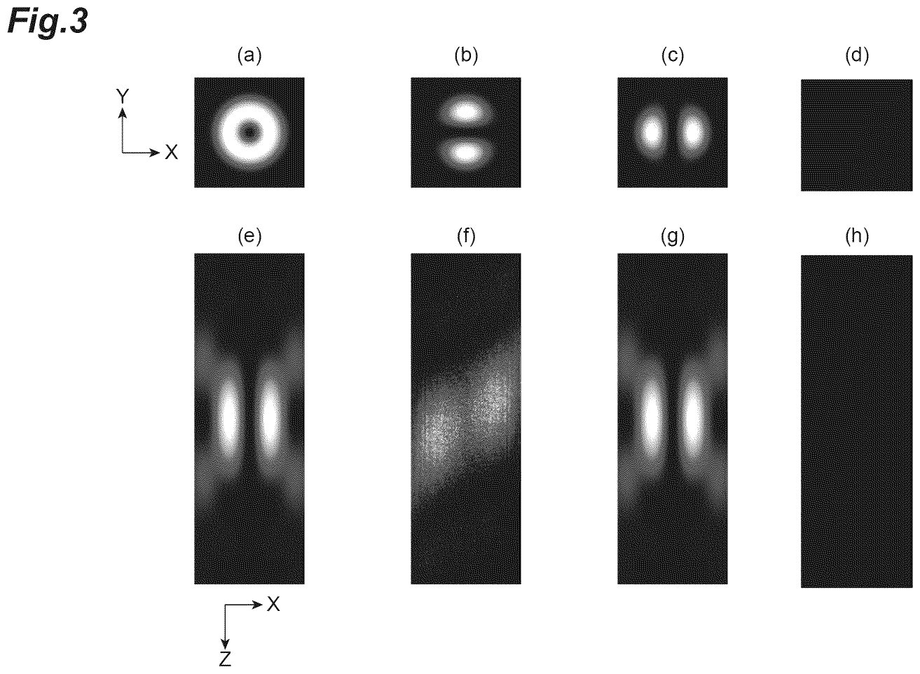

The polarization converter 22 is optically coupled to the light output unit 10 via the beam expander 21. The polarization converter 22 receives the beam La, converts the beam La into azimuthally polarized beam, and outputs the azimuthally polarized beam. The polarization state of the beam La before being input to the polarization converter 22 is, for example, linear polarization. FIG. 2 is a diagram showing a polarization direction of azimuthally polarized beam in a plane perpendicular to an optical axis. In FIG. 2, arrow A indicates the polarization direction. FIG. 3 is a diagram showing focused images of the azimuthally polarized beam. In FIG. 3, the light intensity is shown by color gradation; the darker a portion is, the lower the light intensity is, and the lighter a portion is, the higher the light intensity is. In FIG. 3, parts (a) to (d) show light intensity distributions in planes perpendicular to the optical axis, and parts (e) to (h) show light intensity distributions in planes including the optical axis and parallel to the optical axis. In FIG. 3, parts (b) and (f) show a light intensity (|Ex|²) due to a vibration component Ex of an electric field in an X direction (direction perpendicular to the optical axis). Parts (c) and (g) show a light intensity (|Ey|²) due to a vibration component Ey of the electric field in a Y direction (direction perpendicular to the optical axis and the X direction). Parts (d) and (h) show a light intensity (|Ez|²) due to a vibration component Ez of the electric field in a Z direction (optical axis direction). Parts (a) and (e) show a light intensity (Ex|²+Ey|²+|Ez|²) obtained by combining the vibration components of the electric field in all directions. As shown in FIGS. 2 and 3, in the azimuthally polarized beam, vibration directions of the electric field are along tangential directions of a circumference centered on the optical axis, and the light intensity decreases in the vicinity of the optical axis. Therefore, the light intensity distribution of the azimuthally polarized beam in a plane perpendicular to the optical axis has an annular shape. The polarization converter 22 converts the beam La, which is input from the light output unit 10, into such azimuthally polarized beam, and outputs the azimuthally polarized beam. The polarization converter 22 can be formed of, for example, an azimuth polarizer or two spatial light modulators. The azimuth polarizer may be of a fixed type obtained by processing a glass plate, or a variable type using liquid crystal.

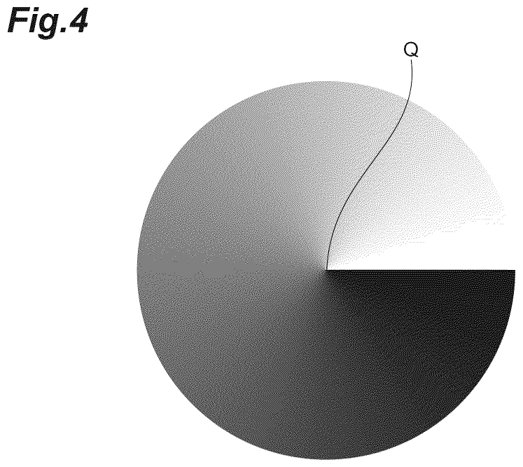

The phase converter 23 is optically coupled to the light output unit 10 via the beam expander 21 and the polarization converter 22. The phase converter 23 receives the beam La, and applies a phase modulation using a spiral phase pattern to the beam La. FIG. 4 is a diagram showing a spiral phase pattern. In FIG. 4, the magnitude of the phase is shown by color gradation; the lighter a portion is, the smaller the phase is, and the darker a portion is, the larger the phase is. As shown in FIG. 4, in the spiral phase pattern, the phase changes monotonically according to the angle around an optical axis Q. In one example, in the spiral phase pattern, the phase changes from 0 (rad) to 2π (rad). Namely, a width of a phase change in one round is 2π (rad). The phase converter 23 can be formed of, for example, a spiral phase plate or a phase modulation type spatial light modulator. The phase plate is, for example, a glass plate processed for phase modulation.

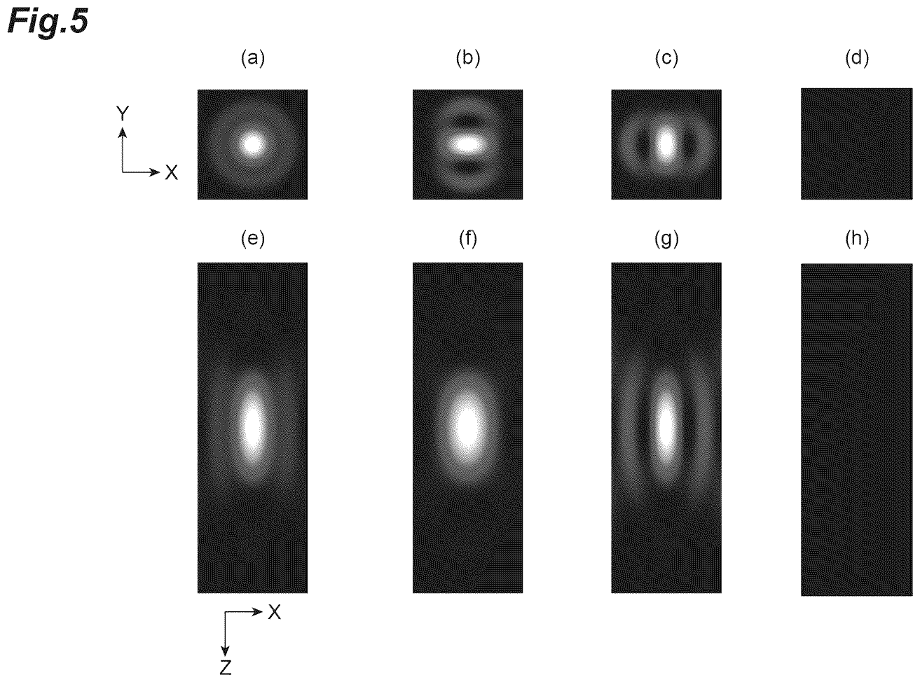

FIG. 5 is a figure showing focused images of beam to which a phase modulation using a spiral phase pattern and azimuthal polarization are applied. In FIG. 5, the light intensity is shown by color gradation; the darker a portion is, the lower the light intensity is, and the lighter a portion is, the higher the light intensity is. In FIG. 5, parts (a) to (d) show light intensity distributions in planes perpendicular to the optical axis, and parts (e) to (h) show light intensity distributions in planes along the optical axis. In FIG. 5, parts (b) and (f) show the light intensity (|Ex|²) due to the vibration component Ex of an electric field in the X direction (direction perpendicular to the optical axis). Parts (c) and (g) show the light intensity (|Ey|²) due to the vibration component Ey of the electric field in the Y direction (direction perpendicular to the optical axis and the X direction). Parts (d) and (h) show the light intensity (|Ez|²) due to the vibration component Ez of the electric field in the Z direction (optical axis direction). Parts (a) and (e) show the light intensity (|Ex|²+|Ey|²+|Ez|²) obtained by combining the vibration components of the electric field in all directions. As shown in FIG. 5, when a spiral phase pattern is combined with azimuthally polarized beam, the light intensity in the vicinity of the optical axis increases. Then, the light intensity distribution in a plane perpendicular to the optical axis changes from an annular shape to a solid circular shape. The beam La has such a solid circular light intensity distribution by passing through the polarization converter 22 and the phase converter 23.

The ring mask 24 is optically coupled to the light output unit 10 via the beam expander 21, the polarization converter 22, and the phase converter 23. The ring mask 24 receives the beam La, spatially modulates the intensity of the beam La in a beam cross section of the beam La, and outputs the modulated beam La. The ring mask 24 includes a light-shielding portion having a ring shape and transmitting portions provided in contact with the inside and the outside of the light-shielding portion. The ring mask 24 of the present embodiment is a so-called multiple ring mask. The ring mask 24 can be formed of, for example, a plate-shaped member in which a light-shielding portion and a transmitting portion are formed, or a phase modulation type spatial light modulator. The plate-shaped member can be configured, for example, by forming a light-shielding film as the light-shielding portion on a light-transmitting plate material. Examples of the ring mask include an amplitude modulation type (also called an intensity modulation type), a phase modulation type, and a composite type thereof. The ring mask 24 of the present embodiment is of an amplitude modulation type.

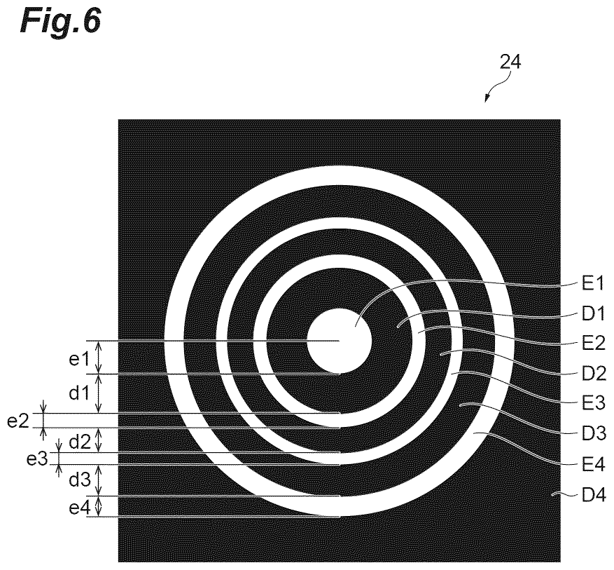

FIG. 6 is a diagram showing one example of a configuration of the ring mask 24 when viewed in the optical axis direction. The ring mask 24 includes a plurality of (three in the shown example) light-shielding portions D1, D2, and D3 having a ring shape and provided around a center position. Furthermore, the ring mask 24 includes a transmitting portion E1 located in an innermost layer and provided inside the light-shielding portion D1; a transmitting portion E2 having a ring shape and provided between the light-shielding portion D1 and the light-shielding portion D2; a transmitting portion E3 having a ring shape and provided between the light-shielding portion D2 and the light-shielding portion D3; a transmitting portion E4 having a ring shape, located in an outermost layer, and provided outside the light-shielding portion D3; and a light-shielding portion D4 provided outside the transmitting portion E4.

A light transmittance of the transmitting portions E1 to E4 is larger than a light transmittance of the light-shielding portions D1 to D4. The light transmittance of the transmitting portions E1 to E4 may be 1 or may be smaller than 1. The light transmittance of the light-shielding portions D1 to D4 may be 0 or may be larger than 0. The boundaries between the transmitting portions and the light-shielding portions adjacent to each other among the transmitting portion E1, the light-shielding portion D1, the transmitting portion E2, the light-shielding portion D2, the transmitting portion E3, the light-shielding portion D3, the transmitting portion E4, and the light-shielding portion D4 may be concentric circles or may be ellipses. The following description will be given based on the assumption that the boundaries are circles. The radius of the transmitting portion E1 is denoted by e1. A radial width of the light-shielding portion D1 is denoted by d1. A radial width of the transmitting portion E2 is denoted by e2. A radial width of the light-shielding portion D2 is denoted by d2. A radial width of the transmitting portion E3 is denoted by e3. A radial width of the light-shielding portion D3 is denoted by d3. A radial width of the transmitting portion E4 is denoted by e4.

The radial width of each of two adjacent light-shielding portions among the light-shielding portions D1, D2, and D3 having a ring shape is larger than the radial width of the transmitting portion provided between the two light-shielding portions. Namely, in the ring mask 24 of the present embodiment, the respective radial widths of the light-shielding portions D1 and D2 and the transmitting portion E2 have a relationship represented by the following formula (1), and the respective radial widths of the light-shielding portions D2 and D3 and the transmitting portion E3 have a relationship represented by the following formula (2). All combinations of two adjacent light-shielding portions having a ring shape may have such a relationship.

$$\begin{matrix}[ Formula 1 ] & \\ \{ \begin{matrix}e 2 < d 1 \\ e 2 < d 2\end{matrix} & ( 1 )\end{matrix}$$

$$\begin{matrix}[ Formula 2 ] & \\ \{ \begin{matrix}e 3 < d 2 \\ e 3 < d 3\end{matrix} & ( 2 )\end{matrix}$$

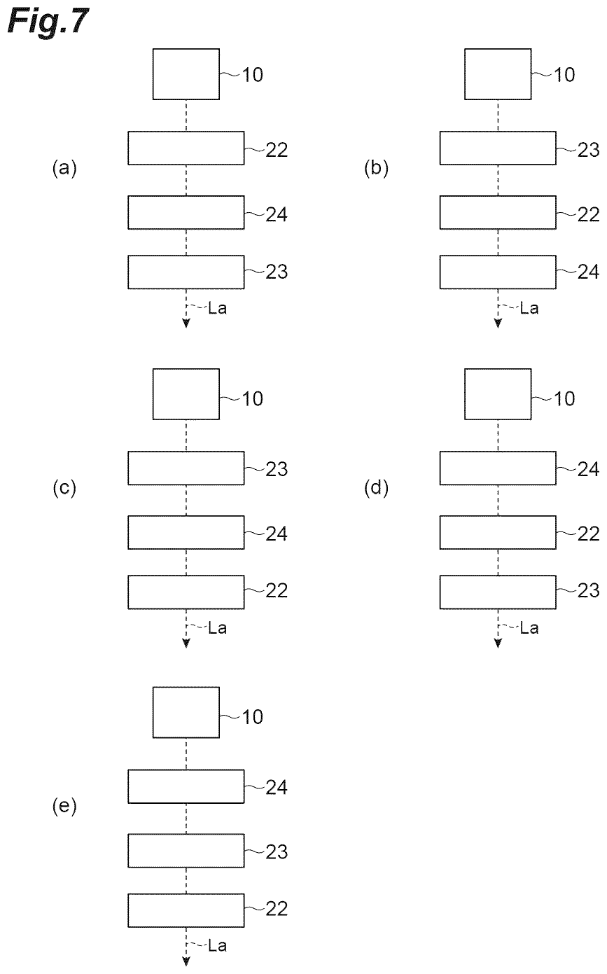

In the present embodiment, the arrangement order of the polarization converter 22, the phase converter 23, and the ring mask 24 is not limited to the example shown in FIG. 1, and can be changed in various modes. The polarization converter 22, the phase converter 23, and the ring mask 24 may be arranged in an order shown in any of parts (a) to (e) of FIG. 7 when viewed from the light output unit 10.

Part (a) of FIG. 7: The polarization converter 22, the ring mask 24, and the phase converter 23 are arranged in order when viewed from the light output unit 10.

Part (b) of FIG. 7: The phase converter 23, the polarization converter 22, and the ring mask 24 are arranged in order when viewed from the light output unit 10.

Part (c) of FIG. 7: The phase converter 23, the ring mask 24, and the polarization converter 22 are arranged in order when viewed from the light output unit 10.

Part (d) of FIG. 7: The ring mask 24, the polarization converter 22, and the phase converter 23 are arranged in order when viewed from the light output unit 10.

Part (e) of FIG. 7: The ring mask 24, the phase converter 23, the polarization converter 22 are arranged in order when viewed from the light output unit 10.

The optical scanner 25 is optically coupled to the beam expander 21 via the polarization converter 22, the phase converter 23, and the ring mask 24. The optical scanner 25 scans the irradiation position of the beam La on the object B by moving the optical axis of the beam La in a plane perpendicular to the optical axis of the beam La. The optical scanner 25 can be formed of various optical scanners such as a galvano scanner, a resonant mirror, or a polygon mirror. In one example, the optical scanner 25 is a two-axis galvano scanner.

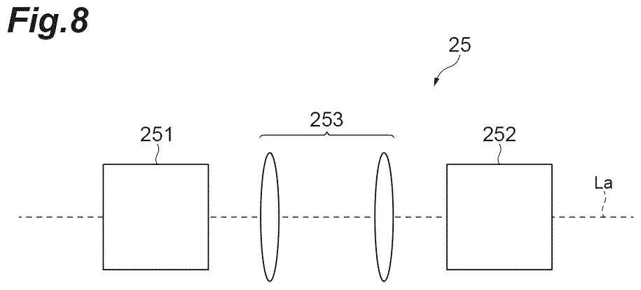

FIG. 8 is a diagram showing another example of the optical scanner 25. The optical scanner 25 shown in FIG. 8 includes two scanners 251 and 252. Both the scanners 251 and 252 are single-axis scanners. A scanning direction of the scanner 251 and a scanning direction of the scanner 252 are orthogonal to each other. The scanner 251 and the scanner 252 are optically coupled to each other via an optical system 253 such as a relay lens. The scanners 251 and 252 are, for example, single-axis galvano scanners. In such a manner, the optical scanner 25 may be configured by combining the single-axis scanners. The irradiation position of the beam La on the object B may be scanned by moving a stage, on which the object B is placed, in a plane perpendicular to the optical axis of the beam La. In that case, the optical scanner 25 may not be provided. When the optical scanner 25 is provided, the polarization converter 22, the phase converter 23, and the ring mask 24 may be provided at the front stage of the optical scanner 25.

The relay lens system 26 is provided on an optical path between the optical scanner 25 and the objective lens 27, and optically couples the optical scanner 25 and the objective lens 27 to each other. The relay lens system 26 is, for example, a telecentric relay lens system. When the optical scanner 25 and the objective lens 27 are extremely close to each other, the relay lens system 26 can also be omitted. A relay lens system similar to the relay lens system 26 may be provided at least one location between the beam expander 21, the polarization converter 22, and the phase converter 23, between the ring mask 24 and the beam expander 21, the polarization converter 22, and the phase converter 23, and between the ring mask 24 and the optical scanner 25.

The objective lens 27 is disposed to face the object B, and focuses the beam La on the surface or inside of the object B. The objective lens 27 is, for example, a dry objective lens, a water immersion objective lens, an oil immersion objective lens, or a silicone immersion objective lens. The objective lens 27 may be an objective lens used to observe a transparent sample. When the objective lens 27 is a water immersion objective lens, a numerical aperture thereof is, for example, 1.2 or more. When the objective lens 27 is an oil immersion objective lens, a numerical aperture thereof is, for example, 1.45 or more. The ratio (NA/R) of a numerical aperture NA of the objective lens 27 to a refractive index R of a medium between the objective lens 27 and the object B is, for example, 0.75 or more. The relative distance between the objective lens 27 and the object B is variable. The objective lens 27 may be movable along the optical axis direction of the beam La. The stage (not shown) on which the object B is placed may be movable along the optical axis direction of the beam La. A mechanism for moving the objective lens 27 or the object B can be formed of, for example, a stepping motor or a piezo actuator. The disposition of the objective lens 27 with respect to the object B may be upright or inverted.

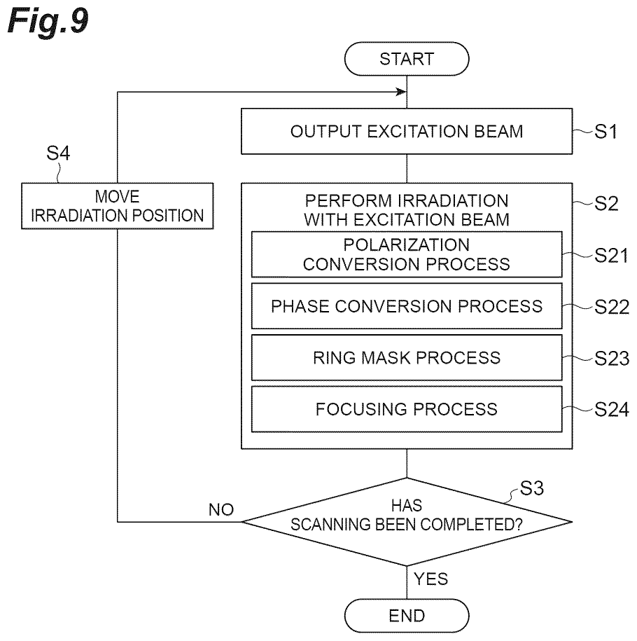

FIG. 9 is a flowchart for describing operation of the light irradiation device 1 according to the present embodiment. A light irradiation method according to the present embodiment will be described with reference to FIG. 9, together with the operation of the light irradiation device 1.

First, a light output step S1 is performed. In the light output step S1, the light output unit 10 outputs the coherent beam La. As described above, the beam La is, for example, a laser beam and pulsed beam. The pulse width of the beam La is, for example, on the order of picoseconds or femtoseconds.

Next, a light irradiation step S2 is performed. In the light irradiation step S2, the object B is irradiated with the beam La output in the light output step S1, via the beam expander 21, the polarization converter 22, the phase converter 23, the ring mask 24, the optical scanner 25, the relay lens system 26, and the objective lens 27. Namely, in the light irradiation step S2, a polarization conversion process S21 by the polarization converter 22, a phase conversion process S22 by the phase converter 23, and a ring mask process S23 by the ring mask 24 are performed on the beam La output in the light output step S1. In the light irradiation step S2, in addition, a focusing process S24 of focusing the beam La on the object B is performed using the objective lens 27. The polarization conversion process S21 is a process of converting the beam La into azimuthally polarized beam. The phase conversion process S22 is a process of applying phase modulation to the beam La using a spiral phase pattern. In the focusing process S24 of the light irradiation step S2, the beam La may be focused using a water immersion objective lens having a numerical aperture of 1.2 or more. Alternatively, in the focusing process S24, the beam La may be focused using an oil immersion objective lens having a numerical aperture of 1.45 or more. Alternatively, in the focusing process S24, the beam La may be focused using the objective lens 27 in which the ratio (NA/R) of the numerical aperture NA of the objective lens 27 to the refractive index R of the medium between the objective lens 27 and the object B is 0.75 or more. Each of the phase conversion process S22 and the ring mask process S23 may be performed using a phase modulation type spatial light modulator.

The light output step S1 and the light irradiation step S2 are repeatedly performed while scanning the irradiation position of the beam La on the object B using the optical scanner 25 (steps S3 and S4). Accordingly, a plurality of positions on the object B can be continuously irradiated with the beam La.

Effects achieved by the light irradiation device 1 and the light irradiation method of the present embodiment described above will be described together with problems of a comparative example.

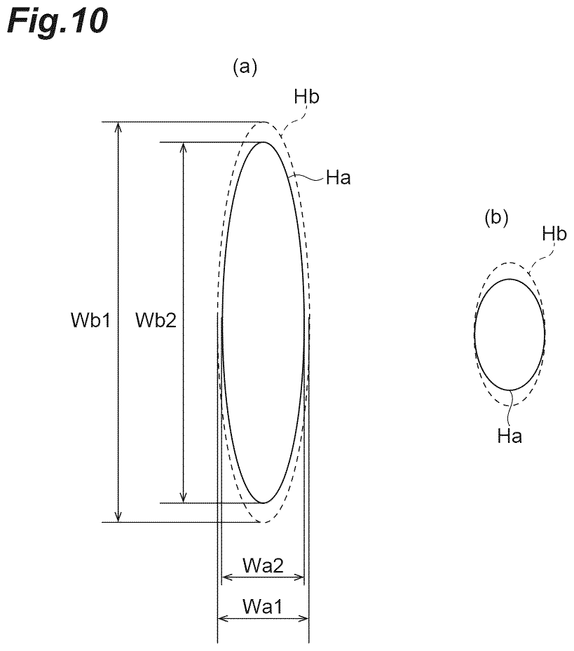

Parts (a) and (b) of FIG. 10 are diagrams showing focused spot shapes in cross sections including the optical axis and parallel to the optical axis. In these diagrams, solid line Ha indicates focused spot shapes when the ring mask is provided, and broken line Hb indicates focused spot shapes when the ring mask is not provided. Part (a) of FIG. 10 assumes that a water immersion objective lens having a numerical aperture of 0.9 is used. Part (b) of FIG. 10 assumes that a water immersion objective lens having a numerical aperture of 1.3 is used. As shown in FIG. 10, the size of the focused spot can be reduced by providing the ring mask.

Tables 1, 2, and 3 below are tables showing one example of a relationship between the numerical aperture of the objective lens and the degree of reduction in focused spot diameter by providing the ring mask in a light irradiation device according to the comparative example in which a multiple ring mask is applied to circularly polarized beam. A volume improvement rate shown in these tables is a value obtained by dividing a volume of a focused spot when the ring mask is not provided by a volume of a focused spot when the ring mask is provided. A lateral improvement rate is a value obtained by dividing a focused spot diameter in the direction perpendicular to the optical axis (diameter Wa1 shown in FIG. 10) when the ring mask is not provided by a focused spot diameter in the direction perpendicular to the optical axis (width Wa2 shown in FIG. 10) when the ring mask is provided, namely, Wa1/Wa2. A longitudinal improvement rate is a value obtained by dividing a focused spot length in the optical axis direction (length Wb1 shown in FIG. 10) when the ring mask is not provided by a focused spot length in the optical axis direction (length Wb2 shown in FIG. 10) when the ring mask is provided, namely, Wb1/Wb2. The focused spot diameter and the focused spot length are full widths at half maximum (FWHM) of a light intensity distribution. In these examples, the ring mask was a multiple ring mask including a quadruple light-shielding portion. A configuration of the ring mask that minimizes the volume of the focused spot under the condition that the light intensity of a side lobe is 2.5% or less of the light intensity of a main lobe, namely, the focused spot, namely, the widths d1 to d3 of the light-shielding portions D1 to D3 and the widths e1 to e4 of the transmitting portions E1 to E4 were searched. Table 1 assumes that the objective lens is a water immersion objective lens. Table 2 assumes that the objective lens is an oil immersion objective lens. Table 3 assumes that the objective lens is a dry objective lens.

TABLE 1

| | | | | | | | | | |
|---|---|---|---|---|---|---|---|---|---|
| Numerical aperture | 1.3 | 1.25 | 1.2 | 1.15 | 1.1 | 1.05 | 1.0 | 0.95 | 0.9 |
| Volume improvement rate (%) | 1.46 | 1.35 | 1.34 | 1.36 | 1.37 | 1.38 | 1.38 | 1.37 | 1.37 |
| Lateral improvement rate (%) | 1.02 | 1.06 | 1.07 | 1.08 | 1.08 | 1.08 | 1.10 | 1.09 | 1.09 |
| Longitudinal improvement rate (%) | 1.41 | 1.21 | 1.18 | 1.16 | 1.17 | 1.17 | 1.14 | 1.15 | 1.15 |

TABLE 2

| | | | | | | | | | | | | |
|---|---|---|---|---|---|---|---|---|---|---|---|---|
| Numerical aperture | 1.5 | 1.49 | 1.45 | 1.42 | 1.40 | 1.35 | 1.3 | 1.25 | 1.20 | 1.15 | 1.10 | 1.05 |
| Volume improvement rate (%) | 1.30 | 1.31 | 1.32 | 1.32 | 1.33 | 1.32 | 1.34 | 1.39 | 1.41 | 1.42 | 1.42 | 1.42 |
| Lateral improvement rate (%) | 1.02 | 1.03 | 1.05 | 1.06 | 1.06 | 1.07 | 1.08 | 1.08 | 1.08 | 1.09 | 1.09 | 1.09 |
| Longitudinal improvement rate (%) | 1.24 | 1.24 | 1.19 | 1.18 | 1.18 | 1.15 | 1.16 | 1.20 | 1.20 | 1.19 | 1.19 | 1.19 |

TABLE 3

| | | | | | | | | | | |
|---|---|---|---|---|---|---|---|---|---|---|
| Numerical aperture | 0.99 | 0.95 | 0.90 | 0.85 | 0.80 | 0.75 | 0.70 | 0.65 | 0.60 | 0.55 |
| Volume improvement rate (%) | 1.30 | 1.32 | 1.31 | 1.34 | 1.40 | 1.42 | 1.44 | 1.45 | 1.57 | 1.76 |
| Lateral improvement rate (%) | 1.02 | 1.05 | 1.07 | 1.08 | 1.08 | 1.09 | 1.10 | 1.10 | 1.12 | 1.12 |
| Longitudinal improvement rate (%) | 1.25 | 1.20 | 1.15 | 1.15 | 1.21 | 1.19 | 1.20 | 1.19 | 1.25 | 1.40 |

As shown in Tables 1 and 2, regardless of the type and numerical aperture of the objective lens, by providing the ring mask, all of the volume improvement rate, the lateral improvement rate, and the longitudinal improvement rate are made larger than 1. However, the lateral improvement rate is small compared to the longitudinal improvement rate. Particularly, in the case of using an objective lens having a large numerical aperture such as a water immersion objective lens having a numerical aperture of 1.05 or more, an oil immersion objective lens having a numerical aperture of 1.25 or more, or a dry objective lens having a numerical aperture of 0.8 or more, the lateral improvement rate is 1.08 or less, and such a tendency is remarkable. It is assumed that a refractive index of a medium between the water immersion objective lens and the object B, namely, an immersion liquid is 1.333, a refractive index of a medium between the oil immersion objective lens and the object B, namely, an immersion liquid is 1.518, and a refractive index of a medium between the dry objective lens and the object B, namely, air is 1. At this time, when the ratio (NA/R) between the numerical aperture NA at which the lateral improvement rate starts to decrease to 1.08 or less and the refractive index R is calculated, the ratio (NA/R) is 0.75 or more for all of the water immersion objective lens, the oil immersion objective lens, and the dry objective lens. When the lateral improvement rate is small, the degree of reduction in focused spot diameter is small, and for example, the degree of improvement in the resolution of the microscope is also small.

Regarding the above-described problems, the inventors have found that the degree of reduction in focusing diameter can be increased by providing the polarization converter 22 that converts the beam into azimuthally polarized beam and the phase converter 23 that applies a phase modulation using a spiral phase pattern, in addition to the ring mask 24, or by performing the polarization conversion process S21 of converting the beam into azimuthally polarized beam and the phase conversion process S22 of applying a phase modulation using a spiral phase pattern.

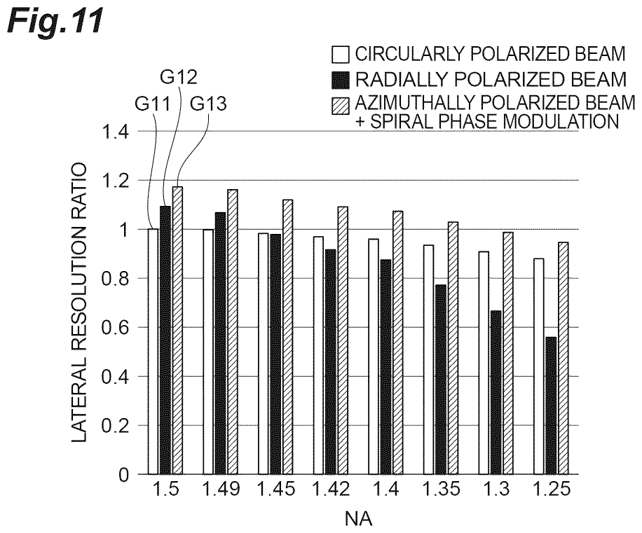

FIG. 11 is a graph showing a lateral resolution ratio for each aperture ratio when the ring mask is not used. In FIG. 11, bars G11, G12, and G13 indicate a case where a beam with which the object is irradiated is circularly polarized beam, a case where the beam is radially polarized beam, and a case where the beam is a combination of azimuthally polarized beam and a spiral phase modulation, respectively. The vertical axis represents the lateral resolution ratio. The lateral resolution ratio is a value obtained by dividing a lateral resolution for the case of an oil immersion objective lens having a numerical aperture of 1.50 and circularly polarized beam by a lateral resolution for each numerical aperture and each polarized beam. The horizontal axis represents the numerical aperture. Referring to FIG. 11, it can be seen that even in the case of not using the ring mask, when a beam with which the object is irradiated is a combination of azimuthally polarized beam and a spiral phase modulation, the lateral resolution ratio is improved at any numerical aperture compared to when light with the object is irradiated is circularly polarized beam or radially polarized beam.

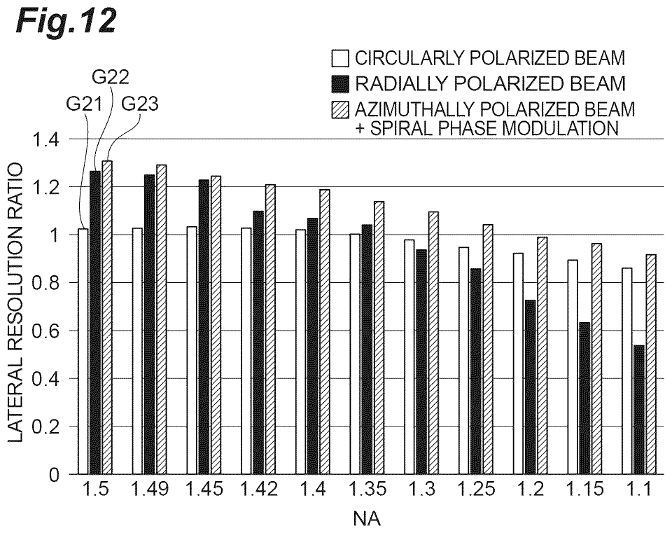

FIG. 12 is a graph showing a lateral resolution ratio for each aperture ratio when the ring mask is used. In FIG. 12, bars G21, G22, and G23 indicate a case where a beam with which the object is irradiated is circularly polarized beam, a case where the beam is radially polarized beam, and a case where the beam is a combination of azimuthally polarized beam and a spiral phase modulation, respectively. The vertical axis represents the lateral resolution ratio. The lateral resolution ratio referred to here is a value obtained by dividing a lateral resolution for the case of an oil immersion objective lens having a numerical aperture of 1.50 and circularly polarized beam when the ring mask is not used by a lateral resolution for each numerical aperture and each polarized beam when the ring mask is used. The horizontal axis represents the numerical aperture. Referring to FIG. 12, it can be seen that when the ring mask is used, even in a case where a beam with which the object is irradiated is in any polarization state, the lateral resolution ratio is improved, but when a beam with which the object is irradiated is a combination of azimuthally polarized beam and a spiral phase modulation, the lateral resolution ratio is significantly improved.

In such a manner, in addition to the ring mask, by irradiating the object with the beam that is a combination of azimuthally polarized beam and a spiral phase modulation, the lateral resolution ratio, in other words, the lateral improvement rate is significantly improved. Therefore, according to the present embodiment, the degree of reduction in focusing diameter can be increased.

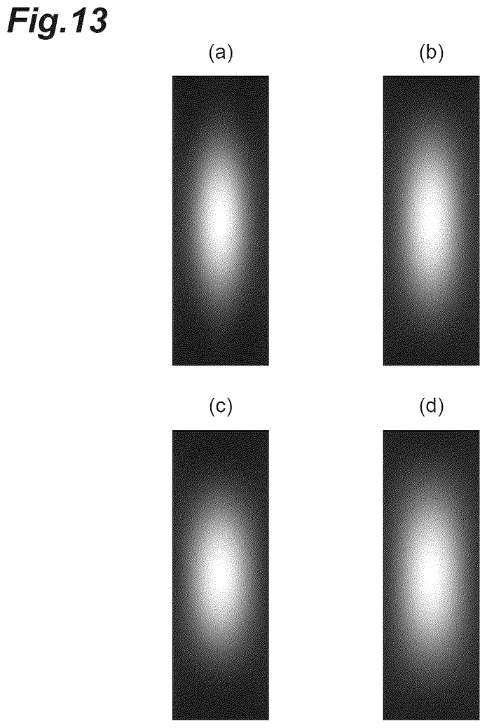

FIG. 13 is a figure showing focused images in cross sections including the optical axis and parallel to the optical axis direction. In FIG. 13, the light intensity is shown by color gradation; the darker a portion is, the lower the light intensity is, and the lighter a portion is, the higher the light intensity is. In FIG. 13, parts (a) and (b) show focused images when the beam La with which the object B is irradiated is a beam obtained by applying spiral phase modulation to azimuthally polarized beam, and parts (c) and (d) show focused images when the beam La with which the object B is irradiated is circularly polarized beam as a comparative example. In FIG. 13, parts (a) and (c) show the focused images when the ring mask 24 is provided, and parts (b) and (d) show the focused images when the ring mask 24 is not provided.

When parts (a) and (c) are compared with parts (b) and (d) in FIG. 13, it can be seen that the focused spot diameter and the focused spot length are reduced when the ring mask 24 is provided compared to when the ring mask 24 is not provided. When parts (a) and (b) are compared with parts (c) and (d) in FIG. 13, it can be seen that the focused spot diameter and the focused spot length are reduced when the beam La with which the object B is irradiated is a beam obtained by applying a spiral phase modulation to azimuthally polarized beam, compared to when the beam La with which the object B is irradiated is circularly polarized beam.

As described above, the ring mask 24 and the ring mask process S23 may be of an amplitude modulation type. Examples of the ring mask include an amplitude modulation type, a phase modulation type, and a composite type thereof. Since a light use efficiency of the phase modulation type is higher than a light use efficiency of the amplitude modulation type, according to the phase modulation type, the irradiation with the beam can be efficiently performed while reducing loss. However, when the phase modulation type ring mask is used, unnecessary focused portions, namely, side lobes are likely to occur on both sides of the focused spot in the optical axis direction. For example, Non Patent Literature 3 discloses that a main lobe is made smaller by causing a side lobe to interfere with the main lobe. For example, in a single-photon excitation fluorescence microscope or the like, since a confocal optical system can be used to increase the resolution through the confocal effect caused by a pinhole, the occurrence of such unnecessary focused portions is allowed to some extent. However, for example, in a two-photon excitation fluorescence microscope or the like, the excitation efficiency is lower than that of the single-photon excitation type, and during observation of a deep portion, a large deviation occurs between the pinhole position and the focusing position due to the influence of an aberration, so that the optical loss is large. When the amplitude modulation type ring mask is used, unnecessary focused portions, namely, side lobes are reduced compared to the phase modulation type, so that the need to provide a confocal optical system including a pinhole is eliminated, which can contribute to downsizing of the device while suppressing optical loss.

The ratio (NA/R) of the numerical aperture NA of the objective lens 27 to the refractive index R of the medium between the objective lens 27 and the object B may be 0.75 or more. Similarly, in the focusing process S24 of the light irradiation step S2, the beam La may be focused using the objective lens 27 in which the ratio (NA/R) of the numerical aperture NA of the objective lens 27 to the refractive index R of the medium between the objective lens 27 and the object B is 0.75 or more. According to the light irradiation device 1 and the light irradiation method of the present embodiment, when the numerical aperture of the objective lens is large in such a manner, the degree of reduction in focusing diameter can be further increased. As the objective lens, a water immersion objective lens, an oil immersion objective lens, a dry objective lens, a silicone immersion objective lens, an objective lens compatible with a clear solution, or the like can be used.

As described above, each of the phase converter 23 and the ring mask 24 may be formed of a phase modulation type spatial light modulator. Similarly, each of the phase conversion process S22 and the ring mask process S23 may be performed using a phase modulation type spatial light modulator. In this case, a change in the phase pattern in the phase converter 23 and the phase conversion process S22 and/or a change in the widths d1 to d3 of the light-shielding portions D1 to D3 and the widths e1 to e4 of the transmitting portions E1 to E4 in the ring mask 24 and the ring mask process S23 can be easily performed.

As described above, the ring mask 24 may include: the plurality of light-shielding portions D1 to D3 having a ring shape and provided around the center position; the transmitting portions E2 and E3, each being provided between two adjacent light-shielding portions among the plurality of light-shielding portions D1 to D3; the transmitting portion E1 located in the innermost layer and provided inside the light-shielding portion D1 located in an innermost layer among the plurality of light-shielding portions D1 to D3; and the transmitting portion E4 located in the outermost layer and provided outside the light-shielding portion D3 located in an outermost layer among the plurality of light-shielding portions D1 to D3. The degree of reduction in focusing diameter can be further increased by using such a multiple ring mask.

### First Modification Example

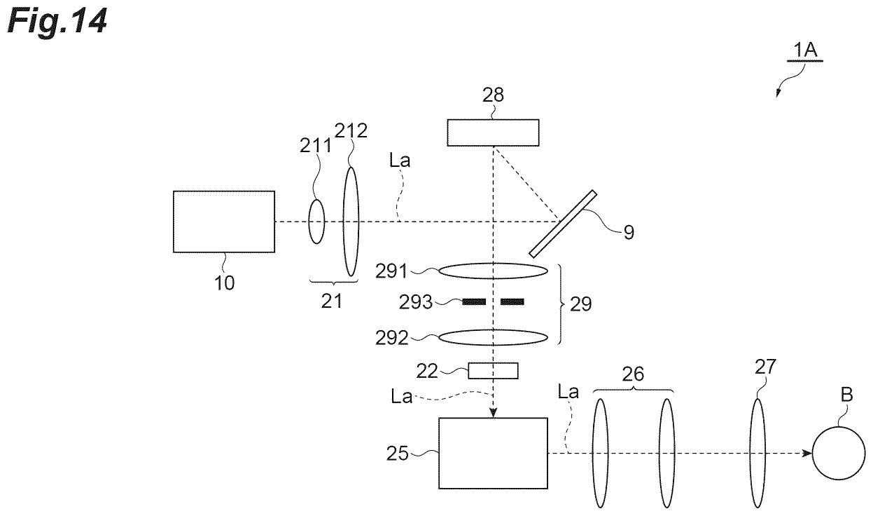

FIG. 14 is a diagram schematically showing a configuration of a light irradiation device 1A according to one modification example of the first embodiment. The light irradiation device 1A differs from the light irradiation device 1 of the first embodiment in that the light irradiation device 1A includes a phase modulation type spatial light modulator 28 and an aperture optical system 29 instead of the phase converter 23 and the ring mask 24 of the light irradiation device 1 described above. The other configurations of the light irradiation device 1A are the same as those of the light irradiation device 1 of the first embodiment. Depending on the relative disposition of the light output unit 10 and the spatial light modulator 28, the light output unit 10 and the spatial light modulator 28 may be optically coupled to each other by, for example, an optical system such as a mirror 9.

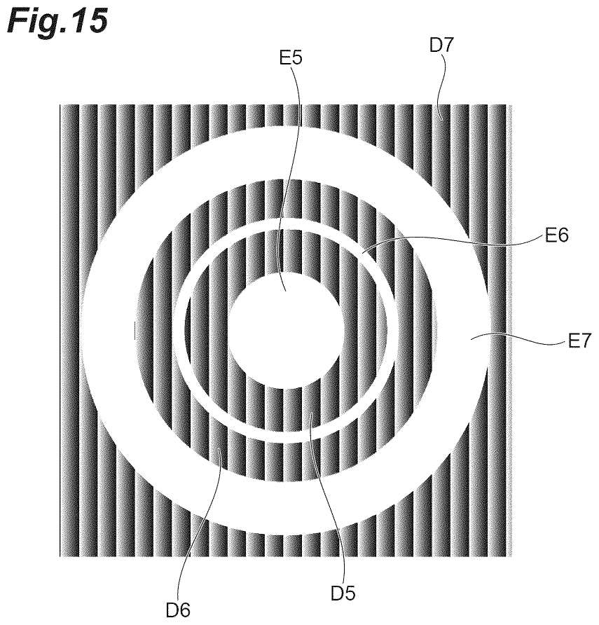

The spatial light modulator 28 has both the function of the phase converter 23 and the function of the ring mask 24. In other words, in the present modification example, a spatial light modulator forming the phase converter 23 is common with a spatial light modulator forming the ring mask 24. The spatial light modulator 28 presents a phase pattern in which a phase pattern forming the phase converter 23 and a phase pattern forming the ring mask 24 are superimposed. A phase pattern for correcting an aberration may be further superimposed on the phase pattern. Particularly, since an aberration that the spatial light modulator 28 itself affects the accuracy of the spiral phase modulation, the aberration is corrected. An aberration that occurs during observation of a deep portion, for example, a spherical aberration that occurs due to a difference in refractive index between the object B and the immersion liquid, and the like may be corrected at the same time by the spatial light modulator 28. The spatial light modulator 28 forms the amplitude modulation type ring mask 24 using a phase pattern. FIG. 15 is a diagram showing an example of the phase pattern forming the amplitude modulation type ring mask 24. In FIG. 15, the phase value of each pixel forming the phase pattern is shown by color gradation; the lighter the color is, the smaller the phase value is, and the darker the color is, the larger the phase value is. In this example, the ring mask 24 is a triple ring mask. Namely, the ring mask 24 includes a plurality of (two in the shown example) light-shielding portions D5 and D6 having a ring shape and provided around the center position. Furthermore, the ring mask 24 includes a transmitting portion E5 located in an innermost layer and provided inside the light-shielding portion D5; a transmitting portion E6 having a ring shape and provided between the light-shielding portion D5 and the light-shielding portion D6; a transmitting portion E7 having a ring shape, located in an outermost layer, and provided outside the light-shielding portion D6; and a light-shielding portion D7 provided outside the transmitting portion E7.

The light-shielding portions D5 to D7 are formed of a grating of which the phase value changes periodically, and the phase values of the transmitting portions E5 to E7 are constant. Specifically, in the light-shielding portions D5 to D7, a phase distribution that monotonically increases from 0 (rad) to 2π (rad) in each period is periodically repeated. Due to such a phase pattern, an emission direction of light emitted from the light-shielding portions D5 to D7 is inclined with respect to an emission direction of light emitted from the transmitting portions E5 to E7.

Referring again to FIG. 14, the aperture optical system 29 is provided at the rear stage of the spatial light modulator 28, and is optically coupled to the spatial light modulator 28. The aperture optical system 29 includes a pair of lenses 291 and 292 and an aperture 293 disposed between the lenses 291 and 292. The beam emitted from the spatial light modulator 28 forms a beam waist between the lens 291 and the lens 292. The aperture 293 is located at the beam waist, and shields at least a part of the beam emitted from the light-shielding portions D5 to D7 of the spatial light modulator 28. Accordingly, the beam emitted from the light-shielding portions D5 to D7 of the spatial light modulator 28 is attenuated or excluded, and the beam emitted from the transmitting portions E5 to E7 passes through the aperture 293. A light transmittance of the transmitting portions is defined as the ratio of a light intensity of the beam, which is emitted from the transmitting portions E5 to E7 to pass through the aperture 293, to a light intensity of the beam incident on the transmitting portions E5 to E7. A light transmittance of the light-shielding portions is defined as the ratio of a light intensity of the light, which is emitted from the light-shielding portions D5 to D7 to pass through the aperture 293, to a light intensity of the light incident on the light-shielding portions D5 to D7. In the present modification example as well, the light transmittance of the transmitting portions is larger than the light transmittance of the light-shielding portions. The light transmittance of the transmitting portions may be 1 or may be smaller than 1. The light transmittance of the light-shielding portions may be 0 or may be larger than 0.

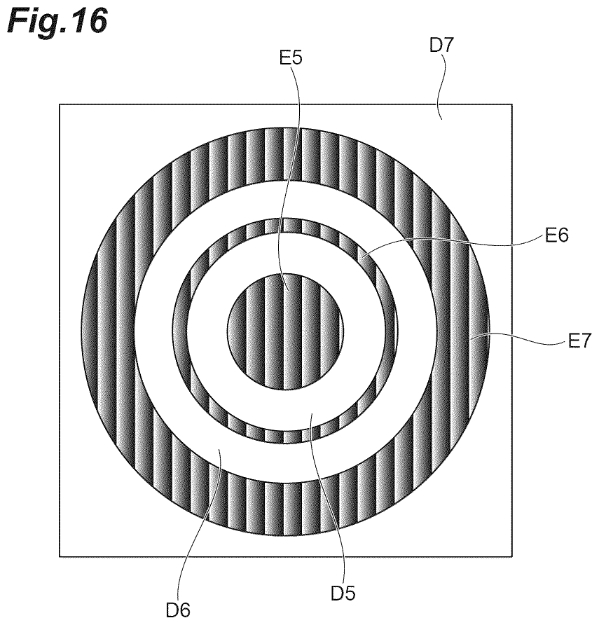

Alternatively, as shown in FIG. 16, the transmitting portions E5 to E7 may be formed of a grating of which the phase value changes periodically, and the phase values of the light-shielding portions D5 to D7 may be constant. Specifically, in the transmitting portions E5 to E7, a phase distribution that monotonically increases from 0 (rad) to 2π (rad) in each period is periodically repeated. Due to such a phase pattern, the emission direction of the beam emitted from the transmitting portions E5 to E7 is inclined with respect to the emission direction of the beam emitted from the light-shielding portions D5 to D7. Then, the position of the aperture 293 is slightly shifted with respect to the beam waist in a direction intersecting the optical axis. Even in such a mode, the aperture 293 can shield at least a part of the beam emitted from the light-shielding portions D5 to D7 of the spatial light modulator 28, and can pass the beam emitted from the transmitting portions E5 to E7 of the spatial light modulator 28.

As in the present modification example, a spatial light modulator forming the phase converter 23 may be common with a spatial light modulator forming the ring mask 24. The common spatial light modulator 28 may present a phase pattern in which a phase pattern forming the phase converter 23 and a phase pattern forming the ring mask 24 are superimposed. Similarly, in the light irradiation method of the first embodiment (refer to FIG. 9), a spatial light modulator that performs the phase conversion process S22 may be common with a spatial light modulator that performs the ring mask process S23, and the spatial light modulator may present a phase pattern in which a phase pattern for performing the phase conversion process S22 and a phase pattern for performing the ring mask process S23 are superimposed. In this case, components forming the phase converter 23 and components forming the ring mask 24, or components that perform the phase conversion process S22 and components that perform the ring mask process S23 are combined into one, so that the configuration of the device can be simplified.

### Second Embodiment

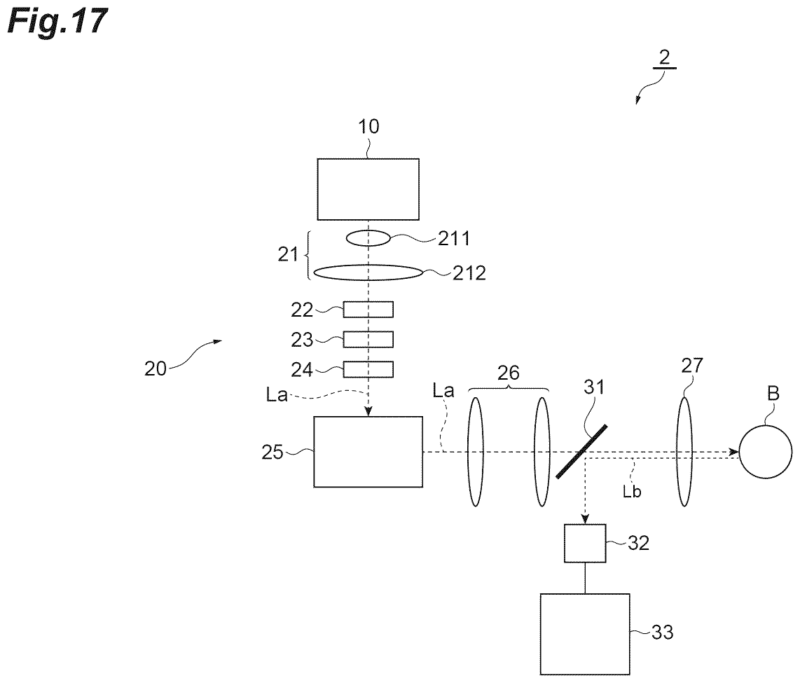

FIG. 17 is a diagram schematically showing a configuration of a microscope device 2 according to one embodiment of the present disclosure. The microscope device 2 is a fluorescence microscope that irradiates the object B with beam La, which is excitation beam, to detect fluorescence Lb obtained from the object B by the irradiation. The microscope device 2 includes the light irradiation device 1 of the first embodiment, a dichroic mirror 31, a detector 32, and an image generator 33. A wavelength of the excitation beam is included in, for example, the near-infrared region. Specifically, the wavelength of the excitation beam is, for example, within a range of 650 nm to 1800 nm. The excitation beam is, for example, laser beam.

The dichroic mirror 31 transmits one of the beam La, which is excitation beam from the optical scanner 25, and the fluorescence Lb from the object B, and reflects the other. In the example shown in FIG. 17, the dichroic mirror 31 transmits the beam La and reflects the fluorescence Lb. In the example shown in FIG. 17, the dichroic mirror 31 is provided on an optical path between the relay lens system 26 and the objective lens 27. The dichroic mirror 31 may be provided between the optical scanner 25 and the relay lens system 26, or may be provided between the beam expander 21 and the optical scanner 25.

The objective lens 27 focuses the beam La on the object B to generate the fluorescence Lb from the object B. The objective lens 27 also has a function of collecting the fluorescence Lb from the object B. In the shown example, the objective lens 27 serves as both an objective lens for the beam La and a lens for collecting the fluorescence Lb in such a manner. The objective lens for the beam La and the lens for collecting the fluorescence Lb may be separately provided. For example, an objective lens having a high numerical aperture (NA) may be used for the beam La to locally focus the beam La through aberration correction. An objective lens having a large pupil may be used for the fluorescence Lb to extract more light. The objective lens for the beam La and the lens for collecting the fluorescence Lb may be disposed to interpose the object B therebetween, so that the fluorescence Lb emitted from a surface on an opposite side of the object B from an incident surface of the beam La is acquired. In that case, the dichroic mirror 31 becomes unnecessary.

The detector 32 detects the fluorescence Lb generated in the object B by the irradiation with the beam La. The detector 32 includes a light detection device that detects the fluorescence Lb. The detector 32 is optically coupled to the dichroic mirror 31. Alternatively, when the objective lens for focusing the beam La and the objective lens for collecting the fluorescence Lb are separately provided, the detector 32 is optically coupled to the objective lens for collecting the fluorescence Lb. The light detection device of the detector 32 generates an electrical signal according to a light intensity of the fluorescence Lb generated in the object B. The light detection device of the detector 32 is sensitive to the wavelength of the fluorescence Lb. The light detection device of the detector 32 can be selected from one-dimensional light detection elements such as a photomultiplier tube and an avalanche photodiode. Alternatively, various two-dimensional light detection elements such as a multi-anode photomultiplier tube (PMT), a CCD image sensor, or a CMOS image sensor may be selected as the light detection device of the detector 32. A filter that cuts the wavelength of the beam La and wavelengths unnecessary for observation may be provided on an optical path between the detector 32 and the dichroic mirror 31 or between the detector 32 and the lens for collecting the fluorescence Lb.

The image generator 33 is electrically connected to the detector 32. The image generator 33 receives a signal related to the light intensity of the fluorescence Lb, which is a detection result, from the detector 32, and generates an observation image of the object B based on the light intensity of the fluorescence Lb. The image generator 33 may be formed of, for example, a computer including a central processing unit (CPU) and a memory. The image generator 33 may further include a monitor that displays the generated image.

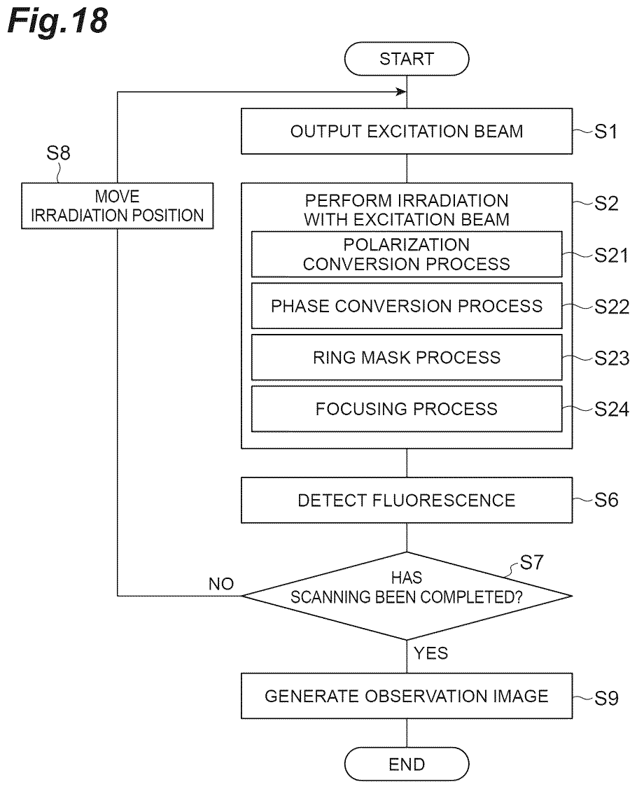

FIG. 18 is a flowchart for describing operation of the microscope device 2 according to the present embodiment. An image acquisition method according to the present embodiment will be described with reference to FIG. 18, together with the operation of the microscope device 2.

First, the light output step S1 and the light irradiation step S2 are performed. Details of the light output step S1 and the light irradiation step S2 are the same as in the first embodiment described above. However, in the present embodiment, the beam La output in the light output step S1 is excitation beam for exciting the object B.

Next, a detection step S6 is performed. In the detection step S6, the detector 32 detects the light intensity of the fluorescence Lb generated in the object B by the irradiation with the beam La. The detection step S6 may include a step in which the light detection device generates a signal according to the light intensity of the fluorescence Lb generated in the object B.

The light output step S1, the light irradiation step S2, and the detection step S6 are repeatedly performed while scanning the irradiation position of the beam La on the object B using the optical scanner 25 (steps S7 and S8). Accordingly, data regarding the light intensity of the fluorescence Lb at a plurality of positions on the object B is obtained.

After the scanning by the optical scanner 25 is completed (step S7: YES), an image generation step S9 is performed. In the image generation step S9, the image generator 33 generates an observation image of the object B based on the detection result in the detection step S6. In the image generation step S9, the image generator 33 may generate an observation image of the object B based on the signal generated by the light detection device of the detector 32.

According to the microscope device 2 and the image acquisition method of the present embodiment described above, the degree of reduction in focusing diameter can be increased by including the light irradiation device 1 of the first embodiment or including the light irradiation method of the first embodiment. Therefore, the resolution of the observation image can be increased.

### Second Modification Example

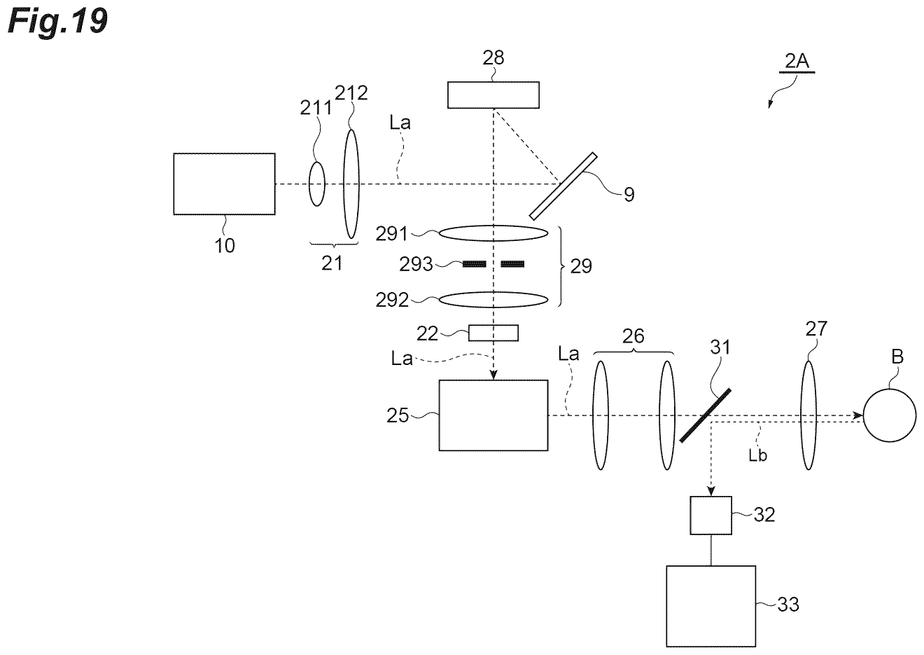

FIG. 19 is a diagram schematically showing a configuration of a microscope device 2A according to one modification example of the second embodiment. The microscope device 2A differs from the microscope device 2 of the second embodiment in that the microscope device 2A includes the phase modulation type spatial light modulator 28 instead of the phase converter 23 and the ring mask 24 of the microscope device 2. The configurations of the spatial light modulator 28 and the aperture optical system 29 are the same as in the first modification example. The other configurations of the light irradiation device 1A are the same as those of the microscope device 2 of the second embodiment. In the present modification example as well, the same actions and effects as in the second embodiment and the first modification example can be achieved.

### Third Embodiment

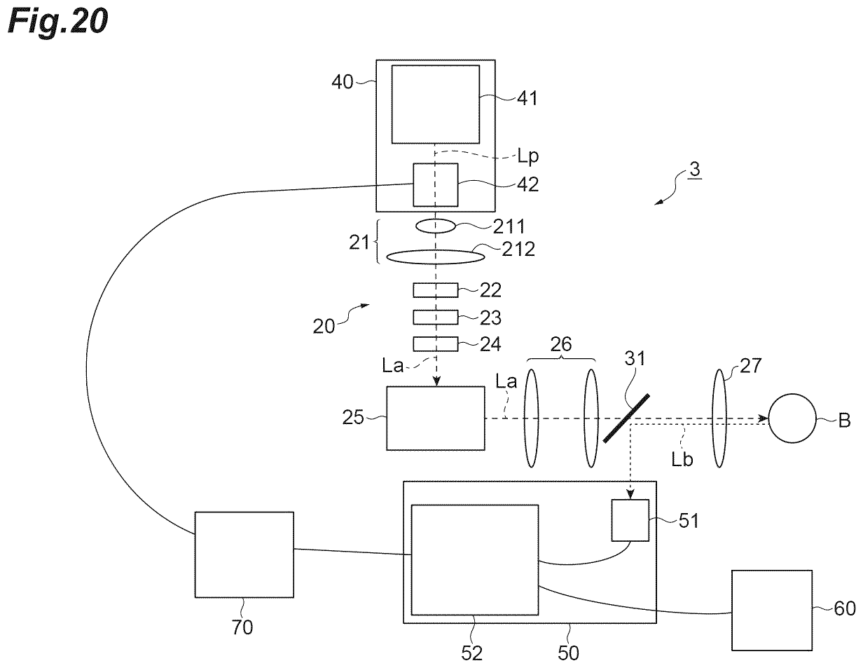

FIG. 20 is a diagram schematically showing a configuration of a microscope device 3 according to one embodiment of the present disclosure. The microscope device 3 includes a light output unit 40, a detector 50, and an image generator 60 instead of the light output unit 10, the detector 32, and the image generator 33 of the microscope device 2 according to the second embodiment described above. The microscope device 3 further includes a signal generator (function generator) 70. The object B is, for example, a biological sample.

The light output unit 40 outputs the beam La that is excitation beam for exciting the object B. The beam La is coherent light. The wavelength of the beam La is included in, for example, the near-infrared region. Specifically, the wavelength of the beam La is, for example, within a range of 650 nm to 1800 nm. The beam La is, for example, laser beam. The following formula (3) is a formula that shows a time waveform of the beam La output from the light output unit 40. In Formula (3), Ir is the light intensity of the beam La, t is time, f is frequency, and a and b are constants.

$$\begin{matrix}[ Formula 3 ] & \\ {I}_{r} = \sqrt{a \cdot sin ( 2 π f \cdot t ) + b} & ( 3 )\end{matrix}$$

As shown in Formula (3), the time waveform of the beam La includes the square root of a linear function of a sine wave. Formula (4) is a formula that shows one example of the time waveform of the beam La, namely, the case of a=½, f=½π, and b=½.

$$\begin{matrix}[ Formula 4 ] & \\ {I}_{r} = \sqrt{( \frac{sin t + 1}{2} )} & ( 4 )\end{matrix}$$

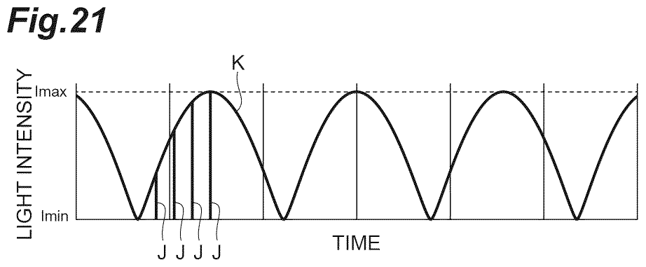

FIG. 21 is a diagram showing the time waveform of the beam La shown in Formula (4). In FIG. 21, the vertical axis represents the light intensity (power) of the beam La, and the horizontal axis represents time. The time waveform of the beam La shown in FIG. 21 periodically repeats between a light intensity Imin (minimum value) and a light intensity Imax (maximum value). The rate of change over time in the vicinity of the maximum value Imax, namely, the peak value of the light intensity in each period is relatively small (gentle). On the other hand, the rate of change over time in the vicinity of the minimum value Imin, namely, the bottom value of the light intensity in each period is relatively large (steep). The maximum value Imax of the light intensity of the beam La in each period is set to a size larger than a saturation excitation intensity of the object B. The light output unit 40 generates the beam La of which the light intensity changes periodically in such a manner, in synchronization with a periodic signal from the signal generator 70. A period of the time waveform of the beam La is approximately several GHz to 1 MHz, and in one example, is 80 MHz. In FIG. 21, the time waveform of the period is shown as a pulse group including a plurality of pulses J (only some of which are shown in the diagram) having a comb shape and having different intensities. On the other hand, a period of an envelope K connecting the peaks of the plurality of pulses J included in the pulse group is, for example, approximately several tens of kHz to several hundred kHz, and in one example, a frequency of the envelope K is 200 kHz or less. The frequency f refers to the frequency of the envelope K.

The light output unit 40 in one embodiment includes a light source 41 and a light modulator 42. The light source 41 outputs pulsed beam Lp. The light source 41 outputs the pulsed beam Lp having, for example, a time width on the order of picoseconds or femtoseconds. Here, the time width of the pulsed beam Lp is, for example, a time for which the light intensity of the pulsed beam Lp is higher than half the peak value. Specifically, the time width of the pulsed beam Lp is, for example, within a range of 10 femtoseconds to 50 picoseconds. The light source 41 is, for example, a laser light source, and in one example, is a mode-locked laser light source. The wavelength range of the pulsed beam Lp is the same as the wavelength range of the beam La described above.

The light modulator 42 is an intensity modulation type light modulator, and is optically coupled to the light source 41 via a space or an optical waveguide. The light modulator 42 is electrically connected to the signal generator 70, and generates the beam La by modulating the pulsed beam Lp output from the light source 41, in synchronization with the output signal from the signal generator 70. For example, the light modulator 42 can be selected from various modulators such as an electro-optic (EO) modulator, an acousto-optic (AO) modulator, and a liquid crystal or neutral density (ND) filter capable of dynamically controlling the transmittance or reflectance. When the time width of the pulsed beam Lp is on the order of femtoseconds, an AO modulator or an EO modulator can be used as the light modulator 42. The beam La may be generated by controlling the magnitude of a drive current input to the light source 41 instead of using the light modulator 42. Such a method is called a direct modulation method. In this case, the light modulator 42 is unnecessary.

The objective lens 27 focuses the beam La on the object B with high density to cause two-photon excitation to occur on the object B, thereby causing the fluorescence Lb to be generated from the object B. The wavelength of the fluorescence Lb is, for example, within a range of 300 nm to 900 nm.

The detector 50 detects a second harmonic included in the time waveform of the light intensity of the fluorescence Lb, or detects both the second harmonic and a third harmonic included in the time waveform of the light intensity of the fluorescence Lb. In one embodiment, the detector 50 includes a light detection device 51 and a lock-in amplifier 52. The light detection device 51 is optically coupled to the dichroic mirror 31. Alternatively, when an objective lens for focusing the beam La and an objective lens for collecting the fluorescence Lb are separately provided, the light detection device 51 is optically coupled to the objective lens for collecting the fluorescence Lb. The light detection device 51 generates an electrical signal according to the light intensity of the fluorescence Lb generated in the object B. The light detection device 51 is sensitive to the wavelength of the fluorescence Lb and has a frequency range required to detect the second harmonic (or both the second harmonic and the third harmonic) of the fluorescence Lb. The light detection device 51 can be selected from one-dimensional light detection elements such as a photomultiplier tube and an avalanche photodiode. Alternatively, various two-dimensional light detection elements such as a multi-anode PMT, a CCD image sensor, or a CMOS image sensor may be selected as the light detection device 51. A filter that cuts the wavelength of the beam La and wavelengths unnecessary for observation may be provided on an optical path between the detector 50 and the dichroic mirror 31 (or the lens for collecting the fluorescence Lb).

The lock-in amplifier 52 is electrically connected to the light detection device 51 and the signal generator 70. The lock-in amplifier 52 receives an electrical signal corresponding to the light intensity of the fluorescence Lb from the light detection device 51, and receives a sine wave signal, which has the same period as the periodic signal provided to the light output unit 40, from the signal generator 70. The lock-in amplifier 52 detects a second harmonic included in the time waveform of the signal from the light detection device 51 or detects one or both of the second harmonic and a third harmonic while using the signal from the signal generator 70 as a reference.

The image generator 60 is electrically connected to the lock-in amplifier 52. The image generator 60 receives a signal related to the magnitude of the second harmonic (or both the second harmonic and the third harmonic), which is included in the time waveform of the light intensity of the fluorescence Lb, from the lock-in amplifier 52, and generates an observation image of the object B based on the second harmonic (or one or both of the second harmonic and the third harmonic). The image generator 60 can be formed of, for example, a computer including a central processing unit (CPU) and a memory. The image generator 60 may further include a monitor that displays the generated image.

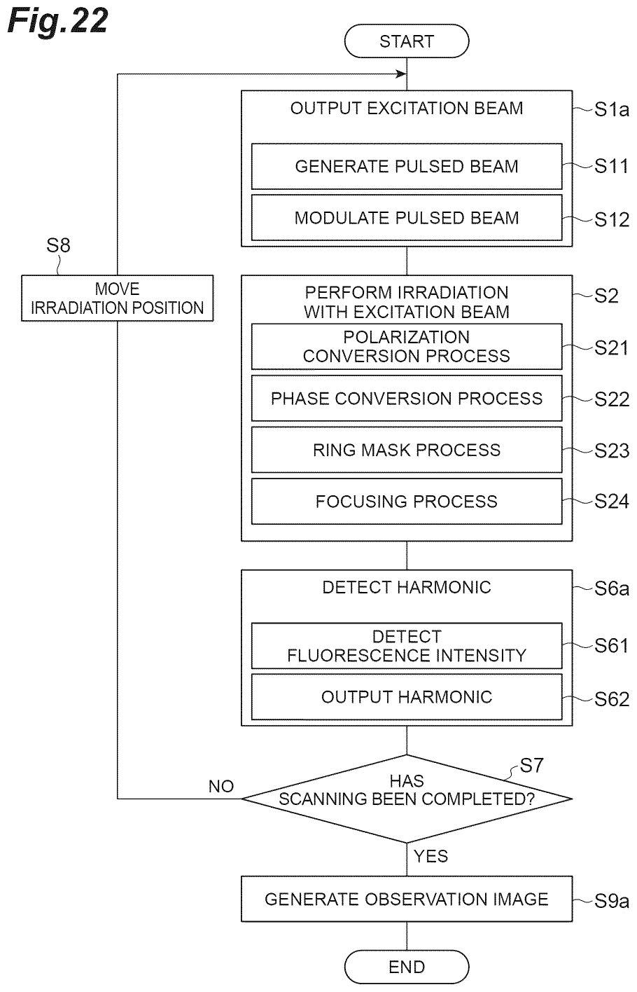

FIG. 22 is a flowchart for describing operation of the microscope device 3 according to the present embodiment. An image acquisition method according to the present embodiment will be described with reference to FIG. 22, together with the operation of the microscope device 3.

First, a light output step S1a is performed. In the light output step S1a, the light output unit 40 outputs the beam La that is excitation beam. As described above, the time waveform of the light intensity of the beam La includes the square root of a linear function of a sine wave (refer to Formula (3)). The maximum value of the light intensity of the beam La in each period is larger than the saturation excitation intensity of the object B. The light output step S1a may include step S11 in which the light source 41 generates the pulsed beam Lp, and an intensity modulation step S12 in which the light modulator 42 modulates the pulsed beam Lp to generate the beam La.

Next, the light irradiation step S2 is performed. Details of the light irradiation step S2 are the same as in the first embodiment described above.

Subsequently, a detection step S6a is performed. In the detection step S6a, the detector 50 detects the second harmonic (or both the second harmonic and the third harmonic) included in the time waveform of the light intensity of the fluorescence Lb generated in the object B due to two-photon excitation by the irradiation with the beam La. The detection step S6a may include step S61 in which the light detection device 51 generates a signal according to the light intensity of the fluorescence Lb generated in the object B, and step S62 in which the lock-in amplifier 52 outputs the second harmonic included in the time waveform of the signal.

The light output step S1a, the light irradiation step S2, and the detection step S6a are repeatedly performed while scanning the irradiation position of the beam La on the object B using the optical scanner 25 (steps S7 and S8). Accordingly, data regarding the magnitude of the second harmonic, the third harmonic, or higher-order harmonics therethan at a plurality of positions on the object B is obtained.

After the scanning by the optical scanner 25 is completed (step S7: YES), an image generation step S9a is performed. In the image generation step S9a, the image generator 60 generates observation images of the object B at a plurality of the irradiation positions of the beam La based on the magnitude of the second harmonic (or one or both of the second harmonic and the third harmonic) included in the time waveform of the light intensity of the fluorescence Lb.

According to the device and the method of the present embodiment described above, the same actions and effects as in the second embodiment can be obtained. In addition, according to the device and the method of the present embodiment, actions and effects to be described below can also be obtained.

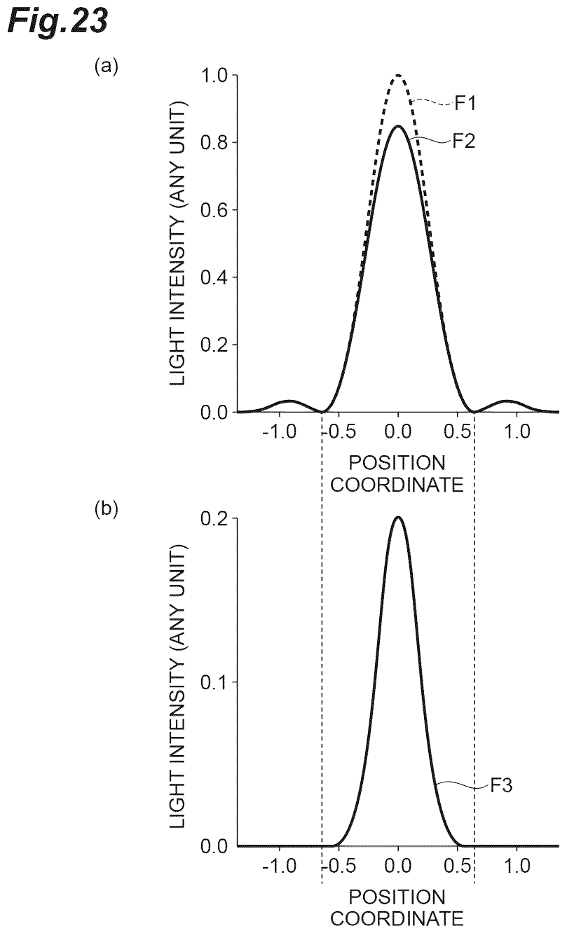

Part (a) of FIG. 23 is a diagram showing one example of a fluorescence intensity distribution in a SAX microscope. In the SAX microscope, the peak intensity of excitation beam is made higher than a saturation excitation intensity of an object to be observed. Accordingly, the fluorescence intensity within a certain range from the center of the fluorescence intensity distribution becomes saturated, and the shape of the fluorescence intensity distribution (solid line F2 in the diagram) changes from a theoretical value when there is no saturation (broken line F1 in the diagram). Therefore, by obtaining a difference between the theoretical value and the measured value of the fluorescence intensity (solid line F3 in part (b) of FIG. 23), the full width at half maximum of the intensity distribution can be reduced and the spatial resolution of the microscope can be increased. In the case of single-photon excitation, the difference between the theoretical value and the measured value of the fluorescence intensity or a value that approximates the difference is obtained by shaping the time waveform of the excitation beam intensity into a sine wave form and by detecting a harmonic (for example, the second harmonic or the third harmonic) of the time waveform of the fluorescence intensity.

In a two-photon excitation microscope, for example, an object to be observed is irradiated with long-wavelength ultrashort-pulse light such as near-infrared light as excitation beam to cause two-photon excitation to occur in the object to be observed, and fluorescence generated accordingly is detected to create an observation image. According to the two-photon excitation microscope, since the long-wavelength light that is excellent in transmitting through an object is used, for example, a deep portion of a biological tissue can be non-invasively observed.

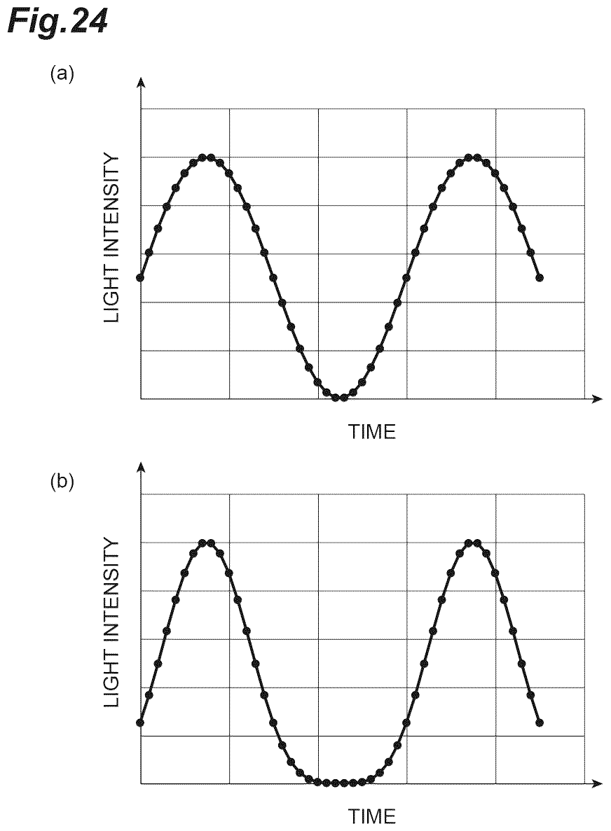

If the SAX microscope and the two-photon excitation microscope having the above-described respective advantages can be combined, a microscope having a combination of these advantages is realized. However, in two-photon excitation, the fluorescence intensity is proportional to the square of the excitation beam intensity. Therefore, when an object to be observed is irradiated with excitation beam having a sinusoidal time waveform to cause two-photon excitation to occur in the object to be observed, the time waveform of the excitation beam output from the object to be observed becomes proportional to the square of the sine wave. FIG. 24 is a diagram conceptually showing the time waveform of such an excitation beam intensity (part (a)) and the time waveform of the fluorescence intensity (part (b)) in the case of two-photon excitation. When an attempt is made to obtain an observation image based on the fluorescence intensity having a time waveform modified from a sine wave as shown in part (b) of FIG. 24, for example, as described in Patent Literature 2, it is necessary to detect a high-order harmonic such as the third harmonic or a fifth harmonic. Since there is a limitation on the maximum value of the frequency range of a device that detects excitation beam, for example, the maximum value of the frequency range of the lock-in amplifier 52, the frequency of the excitation beam has to be reduced when an attempt is made to detect a high-order harmonic, so that the time required to create an observation image is increased.

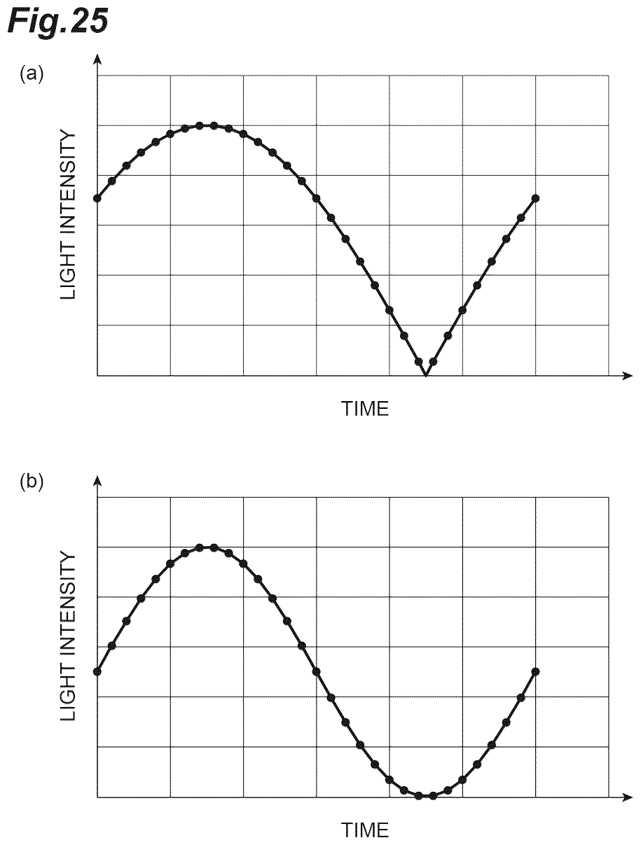

In the microscope device 3 and the image acquisition method of the present embodiment, the time waveform of the light intensity of the beam La includes the square root of a linear function of a sine wave (refer to Formula (3)). As described above, in two-photon excitation, the light intensity of the fluorescence Lb is proportional to the square of the light intensity of the excitation beam. Therefore, when the object B is irradiated with the beam La having a time waveform including the square root of a linear function of a sine wave to cause two-photon excitation to occur in the object B, the time waveform of the beam La output from the object B is not proportional to the square of the sine wave but to the linear function of the sine wave. FIG. 25 is a diagram conceptually showing the time waveform of such an excitation beam intensity (part (a)) and the time waveform of the fluorescence intensity (part (b)).

Therefore, according to the microscope device 3 and the image acquisition method of the present embodiment, similarly to a general SAX microscope, an observation image can be obtained based on a lower-order harmonic such as the second harmonic or the third harmonic. Accordingly, the need to reduce the frequency of the beam La due to a limitation on the frequency range of the light detection device 51 is eliminated, so that an increase in the time required to create an observation image can be avoided.

In order to verify the above-described effects, the inventors measured the light intensity of the fluorescence Lb in the microscope device 3 of the present embodiment, and for comparison, measured the fluorescence intensity by shaping the time waveform of the excitation beam intensity into a sine wave. In these measurements, the excitation beam intensity and the wavelength of the excitation beam were kept the same, and the same object B was used.

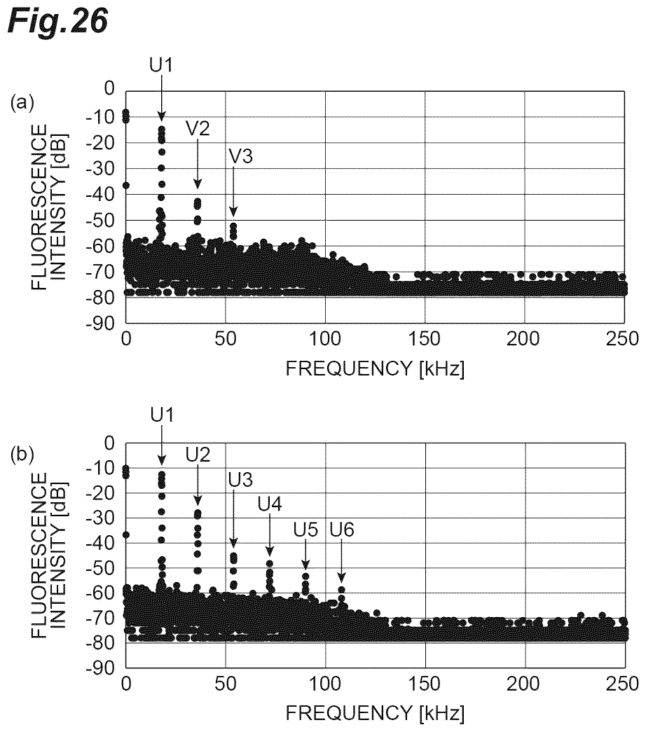

Part (a) of FIG. 26 is a graph showing the result of Fourier transformation of the time waveform of the light intensity of the fluorescence Lb measured in the microscope device 3 of the present embodiment. Part (b) of FIG. 26 is a graph showing the result of Fourier transformation of the time waveform of a fluorescence intensity measured when the time waveform of the excitation beam intensity is a sine wave. Arrow U1 in part (b) of FIG. 26 indicates a fundamental wave, and only the fundamental wave is generated when there is no saturation. When the excitation beam intensity is set to a magnitude at which saturation occurs and the time waveform thereof is a sine wave, as shown in part (b) of FIG. 26, in addition to the fundamental wave, a second harmonic (arrow U2), a third harmonic (arrow U3), a fourth harmonic (arrow U4), a fifth harmonic (arrow U5), and a sixth harmonic (arrow U6) are generated due to saturation. On the other hand, in the microscope device 3 of the present embodiment, as shown in part (a) of FIG. 26, in addition to the fundamental frequency, a second harmonic (arrow V2) and a third harmonic (arrow V3) are generated due to saturation. The fluorescence intensity of the second harmonic (arrow V2) in part (a) of FIG. 26 is approximately equal to the fluorescence intensity of the third harmonic (arrow U3) in part (b) of FIG. 26, and the fluorescence intensity of the third harmonic (arrow V3) in part (a) of FIG. 26 is approximately equal to the fluorescence intensity of the fifth harmonic (arrow U5) in part (b) of FIG. 26.

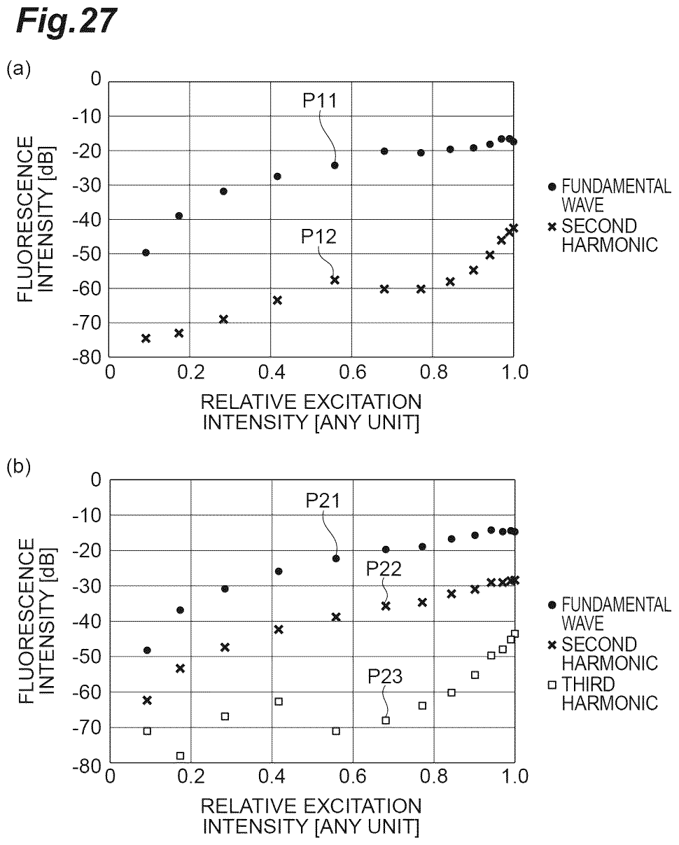

Part (a) of FIG. 27 is a graph showing a relationship between the light intensities of the fundamental wave and the second harmonic of the fluorescence Lb measured in the microscope device 3 of the present embodiment and the relative intensity of the beam La. In part (a) of FIG. 27, plot P11 shows the fundamental wave, and plot P12 shows the second harmonic. Part (b) of FIG. 27 is a graph showing a relationship between the light intensities of the fundamental wave, the second harmonic, and the third harmonic of fluorescence measured when the time waveform of the excitation beam intensity is a sine wave and the relative intensity of the excitation beam. In part (b) of FIG. 27, plot P21 shows the fundamental wave, plot P22 shows the second harmonic, and plot P23 shows the third harmonic. The relative intensity of the excitation beam is the intensity of the periodic excitation beam, namely, the beam La after passing through the light modulator 42, and is a ratio when the maximum intensity that can be output by the light modulator 42 is set to 1. When parts (a) and (b) of FIG. 27 are compared to each other, it can be seen that the disposition of plot P12 in part (a) of FIG. 27, namely, the plot of the second harmonic of the fluorescence Lb measured in the microscope device 3 of the present embodiment and the disposition of plot P23 in part (b) of FIG. 27, namely, the plot of the third harmonic of the fluorescence measured when the time waveform of the excitation beam intensity is a sine wave is approximately similar to each other. It is considered that the reason that the disposition of plot P12 and the disposition of plot P23 in a region where the fluorescence intensity is low are not similar to each other is due to measurement errors.

From the measurement results shown above, in the microscope device 3 of the present embodiment in which the time waveform of the light intensity of the beam La includes the square root of a linear function of a sine wave, it can be seen that the detection of the second harmonic corresponds to the detection of the third harmonic when the time waveform of the excitation beam intensity is a sine wave and the detection of the third harmonic corresponds to the detection of the fifth harmonic when the time waveform of the excitation beam intensity is a sine wave. Namely, according to the microscope device 3 of the present embodiment, an observation image can be obtained based on a lower-order harmonic compared to when the time waveform of the excitation beam intensity is a sine wave. Generally, in many cases, a device of which the upper limit of the frequency range is lower is cheaper than a device of which the upper limit is higher, so that a reduction in cost can be achieved.

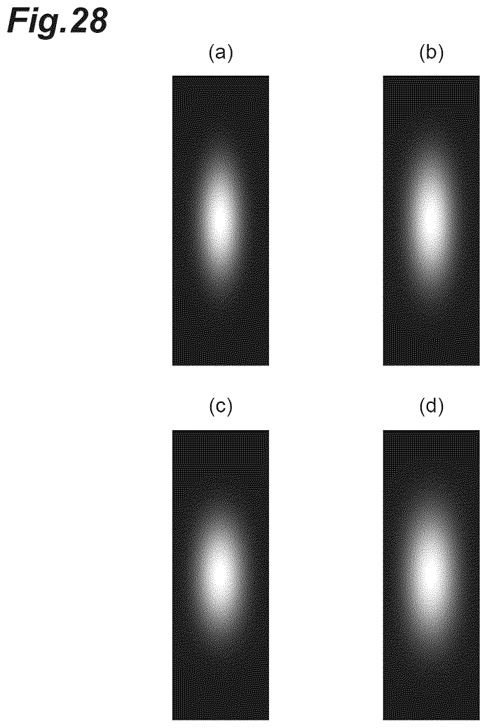

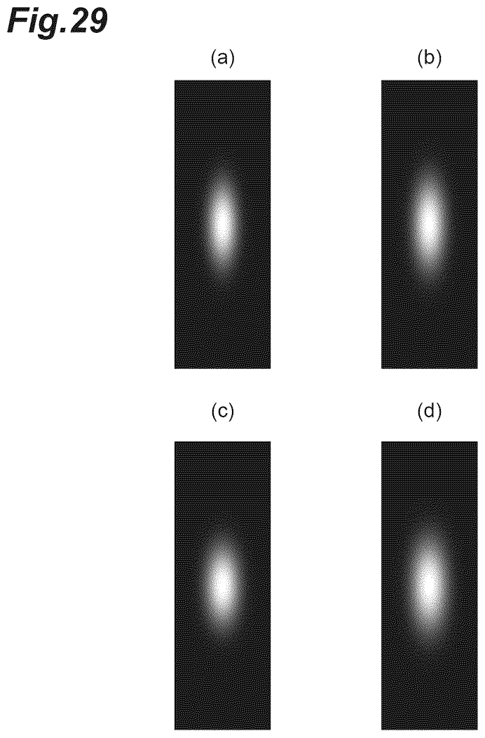

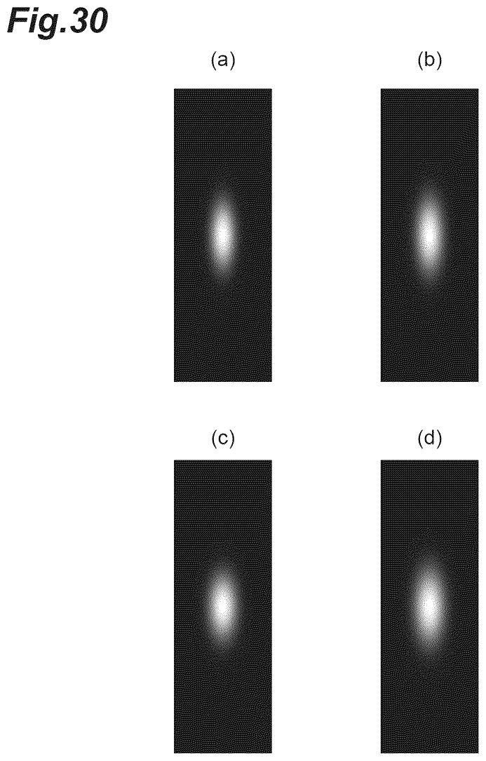

FIG. 28, FIG. 29, and FIG. 30 are figures showing fluorescence images in which the fundamental wave, the second harmonic, and the third harmonic are detected in cross sections including the optical axis and parallel to the optical axis direction, respectively. In these figures, the light intensity is shown by color gradation; the darker a portion is, the lower the light intensity is, and the lighter a portion is, the higher the light intensity is. In FIGS. 28 to 30, parts (a) and parts (b) show fluorescence images when the beam La with which the object B is irradiated is a beam obtained by applying a spiral phase modulation to azimuthally polarized beam, and parts (c) and parts (d) show fluorescence images when the beam La with which the object B is irradiated is circularly polarized beam as a comparative example. In FIGS. 28 to 30, parts (a) and parts (c) show fluorescence images when the ring mask 24 is provided, and parts (b) and parts (d) show fluorescence images when the ring mask 24 is not provided.

When parts (a) and parts (c) are compared with parts (b) and parts (d) in FIGS. 29 and 30, it can be seen that when the ring mask 24 is provided, the dimensions of the fluorescence images in a lateral direction and a longitudinal direction are reduced compared to when the ring mask 24 is not provided. When parts (a) and parts (b) are compared with parts (c) and parts (d) in FIGS. 29 and 30, it can be seen that when the beam La with which the object B is irradiated is a beam obtained by applying a spiral phase modulation to azimuthally polarized beam, the focused spot diameter and the focused spot length are reduced compared to when the beam La with which the object B is irradiated is circularly polarized beam. When FIGS. 29 and 30 are compared to FIG. 28, it can be seen that particularly, the dimensions of the fluorescence images in the lateral direction are reduced by detecting the second harmonic or the third harmonic compared to when the fundamental wave is detected.

As in the present embodiment, the light output unit 40 may include the light source 41 that outputs the pulsed beam Lp, and the intensity modulation type light modulator 42 that modulates the pulsed beam Lp, which is output from the light source 41, to generate the beam La. Similarly, the light output step S1a may include the intensity modulation step S12 of modulating the pulsed beam Lp to generate the beam La. Accordingly, the beam La of which the time waveform of the light intensity includes the square root of a linear function of a sine wave can be easily generated. The intensity modulation type light modulator 42 may be an AO modulator or an EO modulator. The AO modulator and the EO modulator are suitable for modulating high-speed and non-sinusoidal light as in the present embodiment.

As in the present embodiment, the light source 41 may be a laser light source, and the pulsed beam Lp may be laser beam. Accordingly, the beam La having a high light intensity that can cause two-photon excitation to occur can be generated with a simple configuration.

As in the present embodiment, the detector 50 may include the light detection device 51 that generates a signal according to the light intensity of the fluorescence Lb generated in the object B, and the lock-in amplifier 52 that receives the signal from the light detection device 51 and that outputs the second harmonic or both the second harmonic and the third harmonic included in the time waveform of the signal. Similarly, the detection step S6a may include step S61 of generating a signal according to the light intensity of the fluorescence Lb generated in the object B, and step S62 of outputting the second harmonic or both the second harmonic and the third harmonic included in the time waveform of the signal. Accordingly, the second harmonic or both the second harmonic and the third harmonic can be detected easily and accurately.

As in the present embodiment, the detector 50 may detect the second harmonic and the third harmonic included in the time waveform of the light intensity of the fluorescence Lb generated in the object B. Similarly, in the detection step S6a, the second harmonic and the third harmonic included in the time waveform of the light intensity of the fluorescence Lb generated in the object B may be detected. In the image generation step S9a, an observation image of the object B may be generated based on one or both of the second harmonic and the third harmonic. In this case, an observation image can be easily generated using one of the second harmonic and the third harmonic, which is suitable for the object B.

In the present embodiment as well, similarly to the second modification example, the phase modulation type spatial light modulator 28 may be provided instead of the phase converter 23 and the ring mask 24 of the microscope device 2, and the aperture optical system 29 may be provided instead of the beam expander 21 or in addition to the beam expander 21. In this case as well, the same actions and effects as in the present embodiment and the second modification example can be achieved.

### Third Modification Example

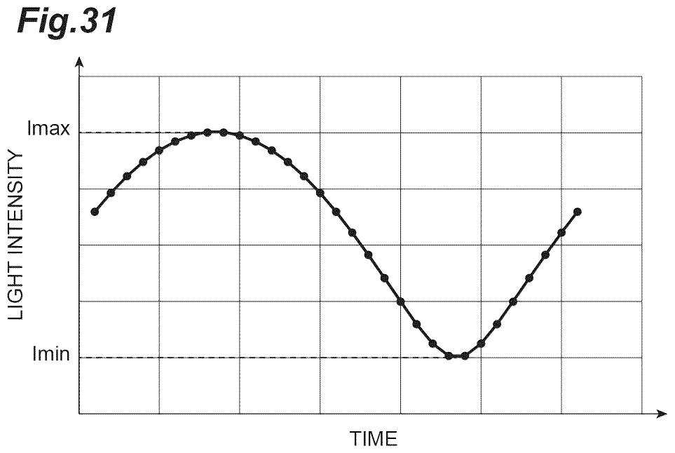

The time waveform of the beam La shown in Formula (3), namely, the time waveform including the square root of a linear function of a sine wave is not limited to the example shown in Formula (4) and FIG. 21. For example, in the example shown in FIG. 21, the minimum value Imin in each period of the time waveform of the beam La, namely, the envelope K is 0; however, the minimum value Imin in each period may be larger than 0. In other words, in Formula (3), the constant b may be larger than a. Alternatively, the minimum value Imin in each period of the time waveform of the beam La may be larger than 0.1% (more preferably 5%) and smaller than 20% of a maximum signal that can be received by the detector 50, specifically, the lock-in amplifier 52. FIG. 31 is a diagram conceptually showing the time waveform of the beam La. In the present modification example as well, the maximum value of the light intensity of the beam La in each period is set to a size larger than the saturation excitation intensity of the object B.

Formula (5) is a formula that shows one example of the time waveform of the beam La in the present modification example. Here, a is a real number larger than 0 and smaller than 1.

$$\begin{matrix}[ Formula 5 ] & \\ {I}_{r} = \sqrt{α ( \frac{sin t + 1}{2} ) + ( 1 - α )} & ( 5 )\end{matrix}$$

The time waveform of the beam La shown in Formula (5) periodically repeats between light intensity (1−α) and light intensity 1. Namely, the maximum value Imax in each period of the time waveform of the beam La is 1, and the minimum value Imin is (1−α).

At the minimum value Imin in each period of the time waveform of the light intensity of the beam La and in the vicinity thereof, the intensity of the generated fluorescence Lb is low, and the detection result thereof is greatly affected by noise. As in the present modification example, by setting the minimum value Imin in each period of the time waveform of the light intensity of the beam La to be larger than 0, the influence of noise is reduced, so that the detection accuracy of the second harmonic can be increased and an observation Image can be made clearer. The minimum value Imin may be larger than 0.1% and smaller than 20% of the maximum signal that can be received by the detector 50 or in the detection step S6a. In that case, an observation image can be made clearer.

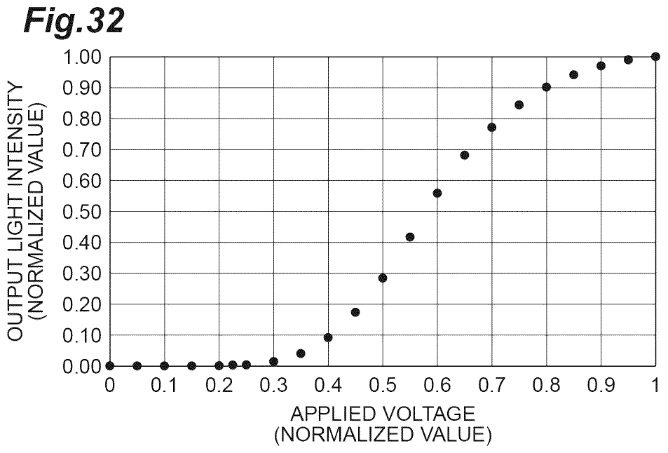

When the time waveform of the light intensity of the beam La includes the square root of a linear function of a sine wave, the rate of change in light intensity in the vicinity of the minimum value Imin in each period increases compared to when the time waveform of the excitation beam intensity is a sine wave. In other words, the time waveform becomes steep. When the minimum value Imin in each period is 0, the rate of change is at its largest (refer to FIG. 21). Here, FIG. 32 is a graph showing a typical example of a relationship between an applied voltage and an output light intensity of a general AO modulator. As shown in FIG. 32, the output light intensity of the AO modulator changes nonlinearly with respect to the input applied voltage. A change in output light intensity in a region where the applied voltage is low is extremely gentle. For this reason, when the rate of change in light intensity is large in a duration for which the light intensity of the beam La is low, it is necessary to rapidly change the applied voltage to the AO modulator, so that the control of the applied voltage becomes difficult. In order to solve such a problem, as in the present modification example, by setting the minimum value Imin in each period to be larger than 0, the rate of change in light intensity in the vicinity of the minimum value Imin in each period is reduced, so that the steepness of the time waveform can be reduced. Therefore, in the light output unit 40 including an AO modulator as the light modulator 42, shaping the time waveform of the light intensity of the beam La, particularly, shaping the time waveform in the vicinity of the minimum value Imin in each period becomes easy. The minimum value Imin may be larger than 0.1% and smaller than 20% of the maximum signal that can be received by the detector 50 or in the detection step S6a. In that case, the above-described effects become more remarkable.

When the minimum value Imin in each period is set to be larger than 0 as described above, the minimum value in each period of the time waveform of the light intensity of the fluorescence Lb also becomes larger than 0. Therefore, when the time waveform of the light intensity of the fluorescence Lb is used as it is in the lock-in amplifier 52, the detection accuracy of the second harmonic and the third harmonic decreases, which is a risk. In order to avoid such a risk, it is desirable to adjust the time waveform in the lock-in amplifier 52 or at the front stage of the lock-in amplifier 52 such that the minimum value in each period of the time waveform of the light intensity of the fluorescence Lb becomes zero. In other words, it is desirable to cancel a variation in the time waveform of the fluorescence Lb due to a difference between the minimum value Imin of the beam La and zero in the lock-in amplifier 52 or at a stage before the lock-in amplifier 52.

### Fourth Modification Example

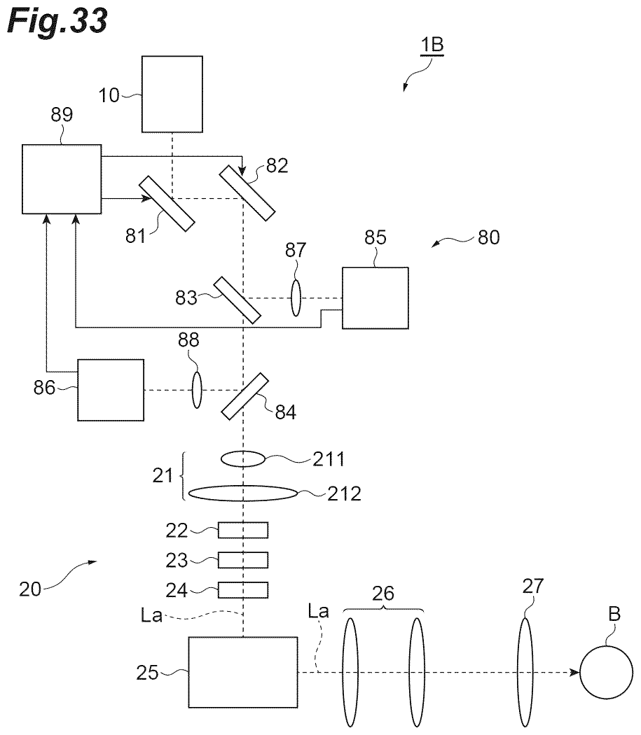

FIG. 33 is a diagram schematically showing a configuration of a light irradiation device 1B according to another modification example of the first embodiment. The light irradiation device 1B differs from the light irradiation device 1 of the first embodiment in that the light irradiation device 1B includes an optical axis adjustment mechanism 80 for adjusting the optical axis of the beam La in addition to the configuration of the light irradiation device 1 described above. The other configurations of the light irradiation device 1B are the same as those of the light irradiation device 1 of the first embodiment.

The optical axis adjustment mechanism 80 is provided on the optical path of the beam La between the light output unit 10 and the optical system 20. The optical axis adjustment mechanism 80 includes a pair of variable angle mirrors 81 and 82, a pair of beam samplers 83 and 84, a pair of cameras 85 and 86, and a control unit 89. The variable angle mirror 81 is optically coupled to the light output unit 10, and reflects the beam La, which is received from the light output unit 10, toward the variable angle mirror 82. The variable angle mirror 82 is optically coupled to the light output unit 10 via the variable angle mirror 81. The variable angle mirror 82 receives the beam La reflected by the variable angle mirror 82, and reflects the beam La toward the optical system 20. Each of the variable angle mirrors 81 and 82 has degrees of freedom in two axes, and can tilt a reflection direction of the beam La at any angle and in any direction. The variable angle mirrors 81 and 82 operate based on electrical drive signals input from the control unit 89.

The beam samplers 83 and 84 are provided on the optical path of the beam La between the variable angle mirror 82 and the optical system 20 with an interval therebetween. The beam samplers 83 and 84 split parts of the beam La. In one example, the beam samplers 83 and 84 reflect a part of the beam La, and transmits the remainder.

The camera 85 is optically coupled to the beam sampler 83 via a lens 87, and receives a part of the beam La split by the beam sampler 83. The camera 86 is optically coupled to the beam sampler 84 via a lens 88, and receives another part of the beam La split by the beam sampler 84. The cameras 85 and 86 capture images of the incident beam, and generate data according to a light intensity distribution. The control unit 89 detects a deviation and an inclination of the optical axis of the beam La based on the data. The control unit 89 provides drive signals to the variable angle mirrors 81 and 82 such that the deviation and the inclination of the optical axis of the beam La approach zero.

The deviation and the inclination of the optical axis of the beam La are caused, for example, by a change in wavelength caused by a variable wavelength laser forming the light output unit 10. Alternatively, the deviation and the inclination of the optical axis of the beam La are caused by a variation over time in output offset and inclination caused by a piezo mirror included in the light output unit 10 for the stability of an output. When the deviation of the optical axis of the beam La, the inclination of the optical axis of the beam La, or both occur, the center position of each of the polarization converter 22, the phase converter 23, and the ring mask 24 and the optical axis of the beam La are not aligned with each other. Therefore, in the present modification example, the deviation and the inclination of the optical axis of the beam La are suppressed by the optical axis adjustment mechanism 80. Accordingly, the center position of each of the polarization converter 22, the phase converter 23, the ring mask 24 and the optical axis of the beam La can be made to more accurately align with each other.

The light irradiation device, the microscope device, the light irradiation method, and the image acquisition method according to the present disclosure are not limited to the embodiments described above, and can be modified in various other modes. For example, in each embodiment, a case where the polarization converter 22, the phase converter 23, and the ring mask 24 are disposed on the optical path between the light output unit 10 and the optical scanner 25 has been provided as an example; however, at least one of the polarization converter 22, the phase converter 23, and the ring mask 24 may be disposed on the optical path between the optical scanner 25 and the objective lens 27. At least one of the polarization converter 22, the phase converter 23, and the ring mask 24 may be disposed on the optical path between the objective lens 27 and the object B.

In each embodiment, a case where the ring mask 24 is of an amplitude modulation type has been provided as an example; however, even when the ring mask 24 is of a phase modulation type or a composite type of an amplitude modulation type and a phase modulation type, as in each embodiment, by using a beam that is a combination of azimuthally polarized beam and a spiral phase, the focusing diameter can be reduced.

In the third embodiment, a case where two-photon excitation is caused to occur in the object B has been described; however, the microscope device and the image acquisition method according to the present disclosure is effective in a case where multiphoton excitation, namely, n-photon excitation (n is an integer of 2 or more) is caused to occur in the object B. Namely, in the intensity modulation step S12 of the light output step S1a, the light modulator 42 of the light output unit 40 outputs the beam La of which the time waveform of the light intensity includes the n-th root of a linear function of a sine wave. Therefore, the terms “two-photon excitation” and “square root” in the embodiments described above can all be replaced with “n-photon excitation” and “n-th root”.

In the third embodiment, the time waveform of the light intensity of the beam La is the square root of a linear function of a sine wave during the entire duration of each period. The present disclosure is not limited to such a mode, and the time waveform of the light intensity of the beam La may be the square root of a linear function of a sine wave only in a part of the duration of each period, typically, only in a duration including the maximum value Imax.

In the second embodiment and the third embodiment, a configuration in which the light irradiation device of the present disclosure is applied to a microscope device has been provided as an example; however, the light irradiation device of the present disclosure is not limited thereto, and can be used for various light irradiation applications such as laser processing and a light stimulation device.

### REFERENCE SIGNS LIST

1, 1A: light irradiation device, 2, 2A: microscope device, 3: microscope device, 9: mirror, 10: light output unit, 20: optical system, 21: beam expander, 22: polarization converter, 23: phase converter, 24: ring mask, 25: optical scanner, 26: relay lens system, 27: objective lens, 28: spatial light modulator, 29: aperture optical system, 31: dichroic mirror, 32: detector, 33: image generator, 40: light output unit, 41: light source, 42: light modulator, 50: detector, 51: light detection device, 52: lock-in amplifier, 60: image generator, 70: signal generator, 211, 212: lens, 251, 252: scanner, 253: optical system, 291, 292: lens, 293: aperture, D1 to D7: light-shielding portion, d1 to d3: width, B: object, J: pulse, K: envelope, E1 to E7: transmitting portion, e1 to e4: width, G11 to G13, G21 to G23: bar, Ha, Hb: focused spot shape, La: beam, Lb: fluorescence, Lp: pulsed beam, S1, Sla: light output step, S2: light irradiation step, S3, S4, S7, S8: step, S6, S6a: detection step, S9, S9a: image generation step, S12: intensity modulation step, S21: polarization conversion process, S22: phase conversion process, S23: ring mask process, S24: focusing process, S61, S62: step, P11, P12, P21 to P23: plot, Q: optical axis, Wa1, Wa2: width, Wb1, Wb2: length.

1. A light irradiation device comprising:
a light source configured to output coherent beam; and
an optical system configured to irradiate an object with the beam output from the light output unit source,
wherein the optical system includes an objective lens that focuses the beam output from the light source on the object, and a polarization converter, a phase converter, and a ring mask that are provided on an optical path between the light source and the object,
the polarization converter is configured to convert the beam input to the polarization converter into azimuthally polarized beam, and to output the azimuthally polarized beam, and
the phase converter is configured to apply a phase modulation using a spiral phase pattern to the beam input to the phase converter.

2. The light irradiation device according to claim 1,
wherein the ring mask is of an amplitude modulation type.

3. The light irradiation device according to claim 1,
wherein a ratio (NA/R) of a numerical aperture NA of the objective lens to a refractive index R of a medium between the objective lens and the object is 0.75 or more.

4. The light irradiation device according to claim 1,
wherein one or both of the phase converter and the ring mask are formed of phase modulation type spatial light modulator.

5. The light irradiation device according to claim 4,
wherein the spatial light modulator forming the phase converter is common with the spatial light modulator forming the ring mask, and
the spatial light modulator presents a phase pattern in which a phase pattern forming the phase converter and a phase pattern forming the ring mask are superimposed.

6. The light irradiation device according to claim 1,
wherein the ring mask includes a plurality of light-shielding portions having a ring shape and provided around a center position, a first transmitting portion provided between two adjacent light-shielding portions among the plurality of light-shielding portions, a second transmitting portion located in an innermost layer provided inside the light-shielding portion located in an innermost layer among the plurality of light-shielding portions, and a third transmitting portion located in an outermost layer and provided outside the light-shielding portion located in an outermost layer among the plurality of light-shielding portions.

7. A microscope device comprising:
the light irradiation device according to claim 1;
a detector configured to detect light generated in the object by irradiation with the beam output from the light source; and
an image generator configured to generate an observation image of the object based on a detection result in the detector.

8. The microscope device according to claim 7,
wherein the detector detects fluorescence generated in the object due to a multiphoton excitation by the irradiation with the beam output from the light source.

9. The microscope device according to claim 7,
wherein the light source outputs light of which a time waveform of a light intensity includes an n-th root (n is an integer of 2 or more) of a linear function of a sine wave and of which a maximum value of the light intensity is larger than a saturation excitation intensity of the object, and
the detector detects a second harmonic included in a time waveform of a light intensity of fluorescence generated in the object due to an n-photon excitation by the irradiation with the beam output from the light source.

10. A light irradiation method comprising:
outputting coherent beam; and
performing a polarization conversion process, a phase conversion process, and a ring mask process on the beam output in the outputting the beam, and focusing the beam on an object,
wherein the polarization conversion process is a process of converting the beam, which is output in the outputting the beam, into azimuthally polarized beam, and
the phase conversion process is a process of applying a phase modulation using a spiral phase pattern to the beam output in the outputting the beam.

11. The light irradiation method according to claim 10,
wherein the ring mask process is of an amplitude modulation type.

12. The light irradiation method according to claim 10,
wherein in the focusing the beam, the beam is focused using an objective lens in which a ratio (NA/R) of a numerical aperture NA of the objective lens to a refractive index R of a medium between the objective lens and the object is 0.75 or more.

13. The light irradiation method according to claim 10,
wherein one or both of the phase conversion process and the ring mask process are performed using phase modulation type spatial light modulator.

14. The light irradiation method according to claim 13,
wherein the spatial light modulator that performs the phase conversion process is common with the spatial light modulator that performs the ring mask process, and
the spatial light modulator presents a phase pattern in which a phase pattern for performing the phase conversion process and a phase pattern for performing the ring mask process are superimposed.

15. An image acquisition method comprising:
the light irradiation method according to claim 10;
detecting light generated in the object by irradiation with the beam in the focusing the beam; and
generating an observation image of the object based on a detection result in the detecting the light.

16. The image acquisition method according to claim 15,
wherein in the detecting the light, fluorescence generated in the object due to a multiphoton excitation by the irradiation with the beam in the focusing the beam is detected.

17. The image acquisition method according to claim 16,
wherein in the outputting the beam, light of which a time waveform of a light intensity includes an n-th root (n is an integer of 2 or more) of a linear function of a sine wave and of which a maximum value of the light intensity is larger than a saturation excitation intensity of the object is output, and
in the detecting the light, a second harmonic included in a time waveform of a light intensity of the fluorescence generated in the object due to an n-photon excitation by the irradiation with the beam in the focusing the beam.
